(19) United States
(12) Patent Application Publication
(10) Pub. No.: US 2025/0358161 A1
(43) Pub. Date: Nov. 20, 2025

(54) A MULTIPLE-SUBCARRIER WAVEFORM FOR BACKSCATTER COMMUNICATIONS

(71) Applicant: QUALCOMM INCORPORATED, San Diego, CA (US)

(72) Inventors: Zhikun Wu, Beijing (CN); Yuchul Kim, San Diego, CA (US); Ahmed Elshafie, San Diego, CA (US); Yu Zhang, San Diego, CA (US); Huilin Xu, Temecula, CA (US); Tingfang Ji, San Diego, CA (US); Wei Yang, San Diego, CA (US); Seyedkianoush Hosseini, San Diego, CA (US); Linhai He, San Diego, CA (US)

(21) Appl. No.: 18/867,366

(22) PCT Filed: Aug. 5, 2022
(86) PCT No.: PCT/CN2022/110446

§ 371 Date: Nov. 19, 2024

(51) Int. Cl. H04L 27/26

(52) U.S. Cl. CPC H04L 27/26025; H04L 27/2614

(57) ABSTRACT

Methods, systems, and devices for wireless communications are described. In some systems, a network entity may determine a subcarrier spacing (SCS) for multiple subcarriers in a continuous wave transmission. The network entity may transmit a control message indicating one or more parameters based on the SCS for the continuous wave transmission. A user equipment (UE) may select one or more parameters of the continuous wave transmission associated with multiple subcarriers. The UE may transmit the continuous wave transmission for activating and communicating with a zero power device. The continuous wave transmission may be modulated with an amplitude shift keying (ASK) modulation scheme and include a set of commands. The zero power device may send signaling in response to the received continuous wave transmission and the set of commands back to the UE.

### CROSS REFERENCE

The present application is a 371 national stage filing of International PCT Application No. PCT/CN2022/110446 by Wu et al. entitled “A MULTIPLE-SUBCARRIER WAVEFORM FOR BACKSCATTER COMMUNICATIONS,” filed Aug. 5, 2022, which is assigned to the assignee hereof, and which is expressly incorporated by reference in its entirety herein.

### FIELD OF TECHNOLOGY

The following relates to wireless communications, including a multiple-subcarrier waveform for backscatter communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support a multiple-subcarrier waveform for backscatter communications. For example, the described techniques provide for a user equipment (UE) to activate and communicate with a zero-power device (e.g., a passive device, a semi-passive device, a semi-active device) using a continuous wave transmission via multiple subcarriers. A network entity may determine a subcarrier spacing (SCS) between multiple subcarriers of the continuous wave transmission. The network entity may transmit a control message to the UE indicating one or more parameters for the continuous wave transmission, which may include parameters based on the SCS. The UE may receive the control message and select one or more parameters for the continuous wave transmission to the zero-power device. Using the selected parameters, the UE may transmit the continuous wave transmission for activating and communicating with the zero-power device via the multiple subcarriers. In some aspects, a portion of the continuous wave transmission may be modulated with an amplitude shift keying (ASK) modulation scheme and include a set of commands. The zero-power device may receive the continuous wave transmission and transmit signaling back to the UE. Such techniques may enable backscatter communications to be implemented within (e.g., to be compatible with) other wireless communications systems (e.g., New Radio (NR) systems).

A method for wireless communication at a UE is described. The method may include selecting, for activating and communicating with a zero power device, one or more parameters of a continuous wave transmission associated with a set of multiple subcarriers, the one or more parameters being based on a SCS between each subcarrier of the set of multiple subcarriers, transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands, and receiving, from the zero power device, signaling responsive to the continuous wave transmission and the set of commands.

An apparatus for wireless communication at a UE is described. The apparatus may include a processor, memory coupled with the processor, and instructions stored in the memory. The instructions may be executable by the processor to cause the apparatus to select, for activating and communicating with a zero power device, one or more parameters of a continuous wave transmission associated with a set of multiple subcarriers, the one or more parameters being based on a SCS between each subcarrier of the set of multiple subcarriers, transmit, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands, and receive, from the zero power device, signaling responsive to the continuous wave transmission and the set of commands.

Another apparatus for wireless communication at a UE is described. The apparatus may include means for selecting, for activating and communicating with a zero power device, one or more parameters of a continuous wave transmission associated with a set of multiple subcarriers, the one or more parameters being based on a SCS between each subcarrier of the set of multiple subcarriers, means for transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands, and means for receiving, from the zero power device, signaling responsive to the continuous wave transmission and the set of commands.

A non-transitory computer-readable medium storing code for wireless communication at a UE is described. The code may include instructions executable by a processor to select, for activating and communicating with a zero power device, one or more parameters of a continuous wave transmission associated with a set of multiple subcarriers, the one or more parameters being based on a SCS between each subcarrier of the set of multiple subcarriers, transmit, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands, and receive, from the zero power device, signaling responsive to the continuous wave transmission and the set of commands.

In some examples of the method, apparatuses, and non-transitory computer-readable medium described herein, selecting the one or more parameters may include operations, features, means, or instructions for selecting a phase, an amplitude, or both for the continuous wave transmission based on a value of a peak-to-average-power ratio (PAPR) being below a threshold value, the one or more parameters including the phase, the amplitude, or both, where the phase, the amplitude, or both may be applied to the continuous wave transmission for activating and communicating with the zero power device.

Some examples of the method, apparatuses, and non-transitory computer-readable medium described herein may further include operations, features, means, or instructions for receiving a message indicating a configuration for generating the phase, the amplitude, or both for the continuous wave transmission, where the phase, the amplitude, or both may be selected based on the configuration.

In some examples of the method, apparatuses, and non-transitory computer-readable medium described herein, the phase may be a randomized phase and the method, apparatuses, and non-transitory computer-readable medium may include further operations, features, means, or instructions for determining the randomized phase, the randomized amplitude, or both based on a Zadoff Chu (ZC) sequence, or a fast Fourier transform (FFT), or a discrete Fourier transform (DFT), or an M-sequence, or any combination thereof.

In some examples of the method, apparatuses, and non-transitory computer-readable medium described herein, selecting the one or more parameters may include operations, features, means, or instructions for selecting a symbol duration of the continuous wave transmission based on an inverse of a multiple of the SCS, where the one or more parameters include the symbol duration.

Some examples of the method, apparatuses, and non-transitory computer-readable medium described herein may further include operations, features, means, or instructions for applying a linear phase ramp to one or more subcarriers of the set of multiple subcarriers to shift the continuous wave transmission in a time domain, where the set of commands includes information modulated in accordance with a pulse position modulation scheme that may be based on the shifted continuous wave transmission.

Some examples of the method, apparatuses, and non-transitory computer-readable medium described herein may further include operations, features, means, or instructions for receiving a message indicating a configuration of the SCS, where the one or more parameters may be selected based on the configuration, and where a symbol duration of the continuous wave transmission may be based on the SCS.

Some examples of the method, apparatuses, and non-transitory computer-readable medium described herein may further include operations, features, means, or instructions for receiving a message indicating a configuration of a symbol duration of the continuous wave transmission, where the one or more parameters may be selected based on the configuration, and where the SCS may be based on the symbol duration.

In some examples of the method, apparatuses, and non-transitory computer-readable medium described herein, respective subcarriers of the set of multiple subcarriers may be non-contiguous in a frequency domain based on the SCS.

In some examples of the method, apparatuses, and non-transitory computer-readable medium described herein, the one or more parameters include a phase associated with the set of multiple subcarriers, an amplitude associated with the set of multiple subcarriers, a symbol duration of the continuous wave transmission, or any combination thereof.

Some examples of the method, apparatuses, and non-transitory computer-readable medium described herein may further include operations, features, means, or instructions for modulating the continuous wave transmission using the ASK modulation scheme.

In some examples of the method, apparatuses, and non-transitory computer-readable medium described herein, the zero power device includes passive components or active components, or both.

A method for wireless communication at a network entity is described. The method may include determining a SCS between a set of multiple subcarriers of a continuous wave transmission for a UE to activate and communicate with a zero power device and transmitting a control message indicating one or more parameters of the continuous wave transmission, the one or more parameters being based on the SCS.

An apparatus for wireless communication at a network entity is described. The apparatus may include a processor, memory coupled with the processor, and instructions stored in the memory. The instructions may be executable by the processor to cause the apparatus to determine a SCS between a set of multiple subcarriers of a continuous wave transmission for a UE to activate and communicate with a zero power device and transmit a control message indicating one or more parameters of the continuous wave transmission, the one or more parameters being based on the SCS.

Another apparatus for wireless communication at a network entity is described. The apparatus may include means for determining a SCS between a set of multiple subcarriers of a continuous wave transmission for a UE to activate and communicate with a zero power device and means for transmitting a control message indicating one or more parameters of the continuous wave transmission, the one or more parameters being based on the SCS.

A non-transitory computer-readable medium storing code for wireless communication at a network entity is described. The code may include instructions executable by a processor to determine a SCS between a set of multiple subcarriers of a continuous wave transmission for a UE to activate and communicate with a zero power device and transmit a control message indicating one or more parameters of the continuous wave transmission, the one or more parameters being based on the SCS.

In some examples of the method, apparatuses, and non-transitory computer-readable medium described herein, transmitting the control message may include operations, features, means, or instructions for transmitting the control message that indicates a configuration for generating a phase for the continuous wave transmission.

Some examples of the method, apparatuses, and non-transitory computer-readable medium described herein may further include operations, features, means, or instructions for selecting a phase, an amplitude, or both for the continuous wave transmission based on a value of a PAPR being below a threshold value, the one or more parameters including the phase, the amplitude, or both.

In some examples of the method, apparatuses, and non-transitory computer-readable medium described herein, the phase may be a randomized phase and the method, apparatuses, and non-transitory computer-readable medium may include further operations, features, means, or instructions for determining the randomized phase, the randomized amplitude, or both based on a ZC sequence, or a FFT, or a DFT, or an M-sequence, or any combination thereof.

Some examples of the method, apparatuses, and non-transitory computer-readable medium described herein may further include operations, features, means, or instructions for selecting a symbol duration of the continuous wave transmission based on an inverse of a multiple of the SCS, where the one or more parameters include the symbol duration.

In some examples of the method, apparatuses, and non-transitory computer-readable medium described herein, transmitting the control message may include operations, features, means, or instructions for transmitting the control message indicating a configuration of the SCS, where a symbol duration of the continuous wave transmission may be based on the SCS.

In some examples of the method, apparatuses, and non-transitory computer-readable medium described herein, transmitting the control message may include operations, features, means, or instructions for transmitting the control message indicating a configuration of a symbol duration of the continuous wave transmission, where the SCS may be based on the symbol duration.

In some examples of the method, apparatuses, and non-transitory computer-readable medium described herein, respective subcarriers of the set of multiple subcarriers may be non-contiguous in a frequency domain based on the SCS.

In some examples of the method, apparatuses, and non-transitory computer-readable medium described herein, the one or more parameters include a phase associated with the set of multiple subcarriers, an amplitude associated with the set of multiple subcarriers, a symbol duration of the continuous wave transmission, or any combination thereof.

### BRIEF DESCRIPTION OF THE DRAWINGS

FIG. 1 illustrates an example of a wireless communications system that supports a multiple-subcarrier waveform for backscatter communications in accordance with one or more aspects of the present disclosure.

FIG. 2 illustrates an example of a wireless communications system that supports a multiple-subcarrier waveform for backscatter communications in accordance with one or more aspects of the present disclosure.

FIGS. 3 and 4 illustrate examples of transmission diagrams that support a multiple-subcarrier waveform for backscatter communications in accordance with one or more aspects of the present disclosure.

FIG. 5 illustrates an example of a process flow in a system that supports a multiple-subcarrier waveform for backscatter communications in accordance with one or more aspects of the present disclosure.

FIGS. 6 and 7 show block diagrams of devices that support a multiple-subcarrier waveform for backscatter communications in accordance with one or more aspects of the present disclosure.

FIG. 8 shows a block diagram of a communications manager that supports a multiple-subcarrier waveform for backscatter communications in accordance with one or more aspects of the present disclosure.

FIG. 9 shows a diagram of a system including a device that supports a multiple-subcarrier waveform for backscatter communications in accordance with one or more aspects of the present disclosure.

FIGS. 10 and 11 show block diagrams of devices that support a multiple-subcarrier waveform for backscatter communications in accordance with one or more aspects of the present disclosure.

FIG. 12 shows a block diagram of a communications manager that supports a multiple-subcarrier waveform for backscatter communications in accordance with one or more aspects of the present disclosure.

FIG. 13 shows a diagram of a system including a device that supports a multiple-subcarrier waveform for backscatter communications in accordance with one or more aspects of the present disclosure.

FIGS. 14 through 19 show flowcharts illustrating methods that support a multiple-subcarrier waveform for backscatter communications in accordance with one or more aspects of the present disclosure.

### DETAILED DESCRIPTION

Some wireless communications systems (e.g., ultra-high frequency (UHF) radio frequency identification (RFID) systems) may include devices that use backscatter communication techniques. Backscatter communication techniques may enable one or more devices to communicate without active radio frequency (RF) components. For example, backscatter communication may enable an RFID tag (e.g., a passive RFID tag, a semi-passive RFID tag, or both) that excludes an internal power source (e.g., battery) or has a limited power supply to communicate with other devices (e.g., which may be referred to as a reading device, a scanning device, or the like). The RFID tag may harvest energy from signals (e.g., electromagnetic waves) that are received over the air to power circuitry used for demodulating the signals and for transmitting information in response to a received command. In some examples, backscatter communications in an RFID system may be limited to a single subchannel (e.g., an industrial, scientific and medical (ISM) band subchannel), and backscatter communications may be affected by selective fading (e.g., frequency selective fading). Such effects may be mitigated via frequency hopping, but frequency hopping in such systems may decrease communications efficiency of backscatter communications.

In some cases, it may be beneficial for one or more devices that support backscatter communications to operate in some different wireless communications systems, such as New Radio (NR) systems or other wireless communications systems. For example, in an NR system, wireless devices may communicate using one or more waveforms, which may define the structure and shape of information signaling between devices. In such cases, a wireless device may communicate via a channel divided into multiple frequency segments (e.g., subcarriers) for transmissions, and the wireless device may use a waveform spanning multiple-subcarriers for transmitting one or more messages to other devices. Such waveforms may enable efficient communications with improved reliability and throughput, among other advantages. As such, techniques to enable backscatter communications, for example, using multiple-subcarrier waveforms, may be desirable.

Techniques, systems, and devices described herein support backscatter communication techniques (e.g., used in RFID systems) that are compatible with NR and other wireless communications systems. For example, a user equipment (UE) may activate and communicate with a zero-power device (e.g., which may be referred to as a zero-power Internet of Things (IoT) device, a passive IoT device, a passive device, a semi-passive device, a semi-active device, an active device, or the like) using a continuous wave transmission sent via multiple subcarriers (e.g., within an NR system).

In some cases, a network entity may determine a subcarrier spacing (SCS) between multiple subcarriers of the continuous wave transmission. The SCS may be the same or different from an SCS used for other communications in the NR system. The network entity may transmit a control message to the UE indicating one or more parameters for the continuous wave transmission, which may include parameters based on the SCS. In some examples, the one or more parameters may include a symbol duration, a phase of the subcarriers, an amplitude of the subcarriers, a linear phase ramp, or any combination of parameters. The UE may receive the control message from the network entity and select one or more parameters for the continuous wave transmission to a zero power device. As used herein, a zero power device may refer to a device that relies on energy harvesting and, optionally, energy storage to operate. In some aspects, a passive device may be one kind of zero power device.

Using the selected parameters, the UE may transmit the continuous wave transmission via the multiple subcarriers for activating and communicating with the zero power device. In some aspects, a portion of the continuous wave transmission may be modulated with an amplitude shift keying (ASK) modulation scheme with a set of commands. For example, the ASK modulation scheme may be a form of amplitude modulation in which a wireless device may transmit a symbol (e.g., a time unit for transmitting bits of information) with a fixed-amplitude carrier wave at a fixed frequency for a specific time duration. The zero-power device may receive the continuous wave transmission and transmit signaling back to the UE. In some examples, the zero-power device may respond to the continuous wave transmission and the set of commands.

Aspects of the disclosure are initially described in the context of wireless communications systems. Aspects of the disclosure are additionally described in the context of transmission diagrams and a process flow. Aspects of the disclosure are further illustrated by and described with reference to apparatus diagrams, system diagrams, and flowcharts that relate to a multiple-subcarrier waveform for backscatter communications.

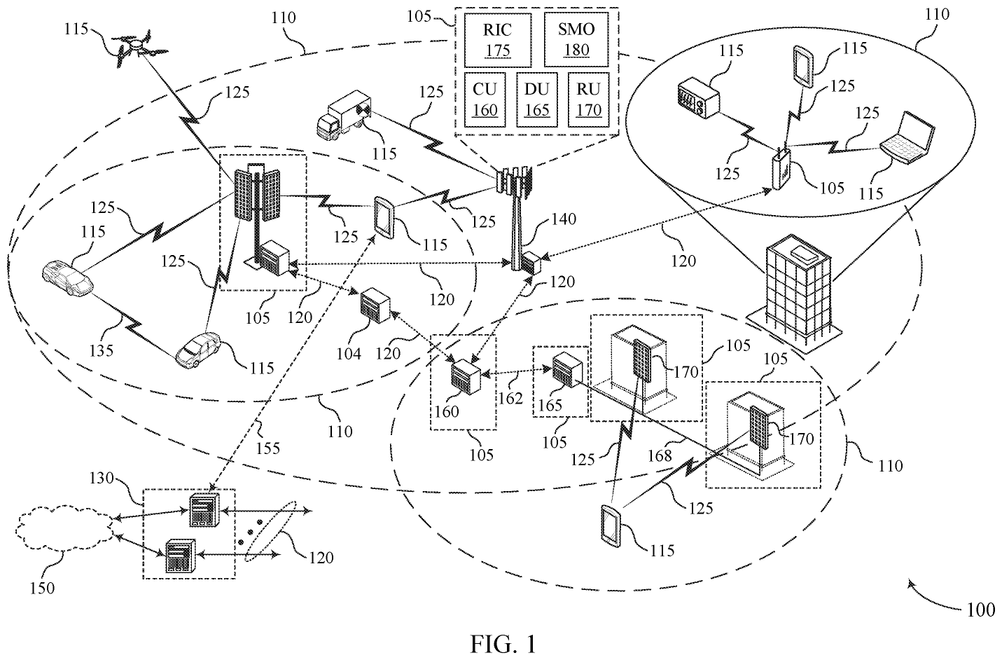

FIG. 1 illustrates an example of a wireless communications system 100 that supports a multiple-subcarrier waveform for backscatter communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support a multiple-subcarrier waveform for backscatter communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

In some aspects, a UE 115 may be an example of a zero power device (e.g., a device that relies on energy harvesting and or energy storage to power an IC for wireless communications), which may be a relatively lightweight IoT device that supports backscatter communication techniques. For instance, a UE 115 may be an example of an RFID device (e.g., an RFID tag). In some examples, a UE 115 may be an example of a passive devices, a semi-passive device, a semi-active device, or an active device. In yet other examples, a UE 115 may support communications with one or more zero power devices. For instance, a UE 115 may be an example of a reader, a scanner, an interrogator, or other type of device that supports backscatter communications and which sends a continuous wave signal to a zero power device. In some aspects, communications associated with one or more zero power devices may be referred to as zero power IoT, passive IoT, or other similar terminology.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may include devices operating in accordance with one or more radio access technologies (RATs). For instance, wireless communications system 100 may be an example of an NR system. In some cases, some communication techniques, such as backscatter communication techniques that are used in RFID systems, may not be fully compatible with the wireless communications system 100. For example, RFID systems, such as UHF RFID systems, may not be compatible with NR systems, as RFID systems may operate in the ISM frequency band (e.g., an unlicensed or shared radio frequency spectrum band), whereas NR systems operate in licensed bands. As such, interaction between conventional RFID systems and NR systems may lack a set of rules that applies to both systems. In some examples, the wireless communications system 100 may provide for communication between one or more wireless devices via waveforms. In some cases, such as in NR systems, one or more wireless devices may communicate using a multi-subcarrier waveform, which may also be referred to as a multiple-subcarrier waveform. In some aspects, one or more network devices operating in the RFID systems may also operate in the NR systems. However, methods for implementing the backscatter communication technique using available subcarriers between RFID system devices and NR systems devices may be deficient.

As described herein, in the wireless communications system 100, a UE 115 may activate or communicate with a zero power device (e.g., a passive device) using a continuous wave transmission according to a multiple subcarriers waveform (e.g., using multiple subcarriers). A subcarrier may be a secondary modulated signal frequency, which may be modulated into a main frequency (e.g., a carrier) to provide an additional channel of transmission. That is, a wireless device may use multiple subcarriers to provide for a signal transmission to carry more than one separate signals (e.g., across multiple sets of frequencies). As such, the continuous wave transmission may be associated with a SCS between respective subcarriers, where the SCS may correspond to gap (e.g., in the frequency domain) between different subcarriers. In some aspects, a network entity 105 may determine the SCS and the network entity 105 may transmit a control message to the UE 115 indicating one or more parameters for the continuous wave transmission, which may include parameters based on the SCS.

In some cases, the UE 115 may receive the control message and select one or more parameters for the continuous wave transmission to the zero power device. Using the selected parameters, the UE 115 may transmit the continuous wave transmission for activating and communicating with the zero power device via the multiple subcarriers. In some aspects, a portion of the continuous wave may be modulated with an ASK modulation scheme with a set of commands. The zero power device may receive the continuous wave transmission and transmit signaling back to the UE 115. A UE 115 using multiple subcarriers for activating and/or communicating with the zero power device may enable backscatter transmissions in the wireless communications system 100 (e.g., an NR system).

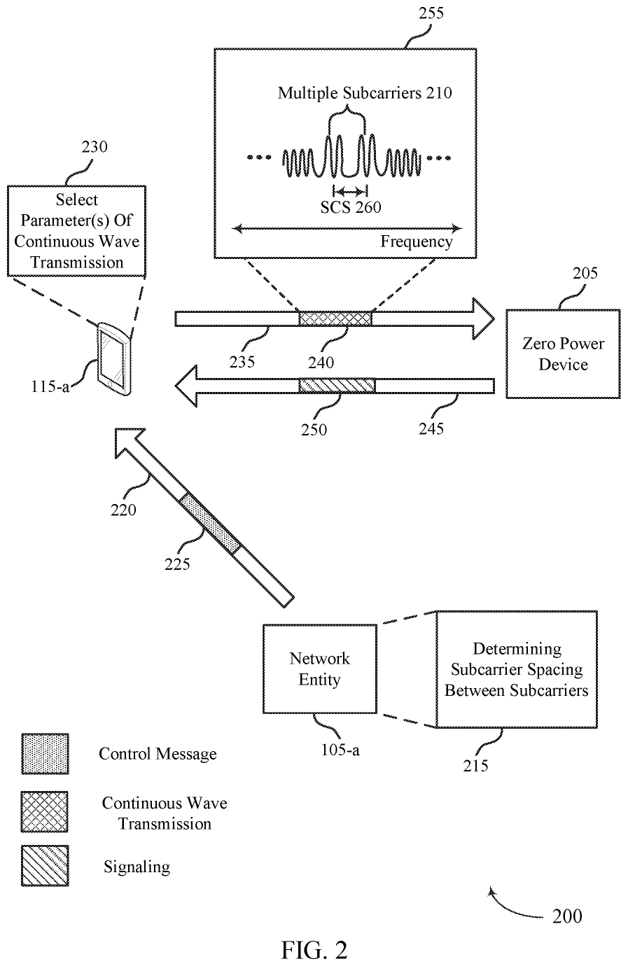

FIG. 2 illustrates an example of a wireless communications system 200 that supports a multiple-subcarrier waveform for backscatter communications in accordance with one or more aspects of the present disclosure. The wireless communications system 200 may implement or be implemented by aspects of the wireless communications system 100. For example, the wireless communications system 200 illustrates a UE 115-a and a network entity 105-a, which may represent examples of corresponding devices as described with reference to FIG. 1.

In the wireless communications system 200, one or more wireless devices may support RFID technology. In some aspects, RFID technology uses digital data encoded into a tag and captured by a reader (e.g., interrogator, scanner) via one or more radio waves. In some examples, RFID systems may include the tag, the reader, and one or more antennas operating in an unlicensed (e.g., shared) radio frequency spectrum band. An RFID tag may include an integrated circuit (IC) and an antenna, among other components, which may provide for the device to transmit data to the reader. For example, the reader may convert signaling into usable data from the RFID tag. The RFID system may also use signaling to activate RFID tags or for communications between wireless devices (e.g., between a zero power device 205 and a reader, such as the UE 115-a). For example, a wireless device may exchange, or transmit, a continuous wave transmission using a forward link and a backward link. The wireless device may send the continuous wave transmission according to a known frequency, and the wireless device may receive a transmission from one or more zero power devices 205 in response to the continuous wave transmission.

In some cases, communications from the UE 115-a to the zero power device 205 (e.g., an RFID tag) may be referred to as forward link communications. The forward link communication may be used to power up the RFID tag (e.g., by sending one or more unmodulated or modulated signals to provide energy to the tag), convey commands or information via one or more modulated signals, and/or provide a backscatter link carrier wave via one or more unmodulated signals. In some other cases, the communication from the zero power device 205 to the UE 115-a may be known as backscatter link, a backward link, or some similar terminology. In some examples, the backscatter link may use a backscatter communication technique that provides for a wireless device to communicate without active radio frequency components. For example, the zero power device 205 may exclude a power source (e.g., a battery), and the backscatter communication techniques may enable the zero power device 205 to harvest energy from received signal to enable to zero power device 205 to demodulate a received command and transmit modulated signaling in response. That is, the zero-power device 205 may harvest energy from signals (e.g., the forward link communication) over the air to power an IC.

In some cases, the wireless communications system 200 may include one or multiple zero power devices 205 (e.g., RFID tags), which may be a relatively lightweight IoT device that supports backscatter communication techniques. A zero-power device 205 may additionally, or alternatively, be referred to as passive devices, semi-passive devices, semi-active devices, or active devices. For example, the wireless communications system 200 may include passive tags, semi-passive tags, semi-active tags, active tags, or any combination thereof. In some cases, passive tags (e.g., passive or zero power devices 205) may not use a power amplifier, a battery, or both while capturing power from the radio wave for performing transmissions. Semi-passive tags may include a battery (e.g., a rechargeable battery) and/or may be equipped with circuitry configured to harvest energy and store energy from one or more energy sources (e.g., radio frequency signals). Semi-active tags may use active transmission techniques and may use a battery for transmissions. Active tags may be classified as IoT devices, where the RF components may use active transmission techniques and may draw power from a battery. In some examples, the semi-active and active tags may be equipped with a transmitter, a receiver, a power source, or any combination thereof, which may provide for active transmission techniques. The semi-active and active tags may use the active transmission techniques to transmit and receive signals (e.g., transmissions, operations, broadcasts) to and from the UE 115-a. However, backscatter communication techniques may use harvested energy from signals to power the tag. As such, tags with passive properties (e.g., passive tags, semi-passive tags) may use the backscatter communication techniques for powering components configured to transmit signals in response to the UE 115-a.

In some aspects, backscatter communication techniques may use an interrogator-talks-first (ITF) procedure between the reader and the tag. The ITF procedure may involve a single waveform, which may define the structure and shape of information in transmitted signals. In some examples, the ITF procedure may use a continuous wave, which may be a sinusoidal wave that is modulated with an information-bearing signal to convey information. For example, one or more wireless devices, such as the UE 115-a, may select a waveform to use to modulate the carrier wave.

In the ITF procedure, the UE 115-a transmits the continuous wave transmission to the zero power device 205, which may enable the zero power device 205 to collect energy from the continuous wave transmission. The collected energy at the zero power device 205 may reach some voltage (e.g., IC voltage on) at which point the zero-power device 205 may turn on (e.g., power up an IC). In some cases, the continuous wave transmission may be transmitted for some duration (e.g., greater than or equal to 400 microseconds (μs)) to power up the zero power device 205. After the duration, the UE 115-a may transmit an information signal (e.g., including one or more commands) to the zero-power device 205, where the information signal may also enable the zero power device 205 to harvest energy and remain active (e.g., powered on). The one or more commands may include instructions for the zero power device 205 to transmit some signaling or information requested by the UE 115-a. The UE 115-a (e.g., a reader) may then transmit the continuous wave transmission to maintain the applied power (e.g., powered up) state of the zero-power device 205 until the UE 115-a receives a response to the one or more commands. In some aspects, the UE 115-a may operate in a full-duplex communications mode to send the continuous wave transmission (to maintain the power at the zero-power device 205) while receiving signaling from the zero power device 205 (in response to a command). In some cases, powering up the zero-power device 205, maintaining the powered up state of the zero-power device 205, and transmitting the power and carrier wave for the tag modulation may use a same waveform.

In some cases, RFID systems may operate in an unlicensed ISM band, where a device may occupy one ISM band subchannel at a time. In such cases, the RFID systems may be impacted by frequency selective fading, which may be a wave propagation anomaly due to partial cancellation of a spectrum of a signal and a channel frequency response. In some cases, the signal may arrive at the receiver via two different paths, where at least one of the paths is changing (e.g., lengthening or shortening). The varying signals may cancel each other out at different points across the channel, which may create nulls (e.g., no transmitted radio waves). The nulls may affect the single-subchannel transmissions, causing reception and/or decoding errors. In some instances, devices in the RFID system may overcome frequency selective fading by using frequency hopping, where a carrier frequency is repeatedly switched during radio transmission. However, frequency hopping may reduce the communication efficiency between the devices.

The wireless communications system 200 may be an example of an NR system, which may support signals sent using multiple subcarriers and OFDM techniques. In some cases, the OFDM techniques may use multiple subchannels (e.g., pathways) that provides for several bits to be transmitted in parallel, or at a same time. The network entity 105-a may communicate with one or more UEs 115, such as the UE 115-a, using multiple RBs and REs (e.g., spanning one or more subcarriers). In some aspects, a data transmission via the OFDM techniques may provide for a single information stream to be split among several relatively closely spaced narrow band subchannel frequencies, instead of a single wideband channel frequency.

In some examples, use a multiple-subcarrier waveform for continuous wave transmissions used in backscatter communications may improve communication efficiency for communications between zero power devices 205 and a UE 115-a. Backscatter communications (e.g., continuous wave transmission) using multiple subcarriers may therefore be performed in accordance with some set of rules that enable compatibility with an NR system (or other wireless communications systems).

In some examples, a UE 115-a, which may be an example of an RFID reader, may activate and/or communicate with a zero power device 205, which may be an example of an RFID tag. In some examples, the UE 115-a may be an RF source for the zero power device 205, such as by performing a transmission via a forward link. In some cases, the network entity 105-a may configure multiple parameters for multiple subcarriers 210 of a continuous wave transmission 240. The UE 115-a may apply the parameters to the continuous wave transmission 240 to activate or communicate with the zero power device 205. For example, the UE 115-a may perform the continuous wave transmission 240 using the multiple subcarriers 210 and according to a SCS 260. The SCS 260 may be equal to the reciprocal of the symbol duration, and may indicate spacing between subcarriers (e.g., peak to peak). For example, the UE 115-a may transmit the continuous wave transmission 240 according to a multiple-subcarrier waveform as illustrated in waveform diagram 255, where the multiple-subcarrier waveform includes multiple subcarriers 210 separated by the SCS 260 in the frequency domain.

At 215, the network entity 105-a may determine the SCS 260 between the multiple subcarriers 210 of the continuous wave transmission 240. The SCS 260 may be based on a capability of the UE 115-a to support the SCS 260 and may be configured by the network entity 105-a, or otherwise defined at the UE 115-a. For example, the network entity 105-a may transmit a control message 225, such as an RRC message, a MAC-CE, DCI, or the like, indicating the SCS to the UE 115-a. In some examples, the UE 115-a may communicate with the zero power device 205 using an SCS 260 that is different than an SCS associated with uplink and downlink communications at the UE 115-a (e.g., in accordance with NR communications). The network entity 105-a may transmit a control message 225 to the UE 115-a indicating the one or more parameters and the SCS 260 for the continuous wave transmission 240. The network entity 105-a may transmit the control message via an uplink communication link 220 to the UE 115-a. In some examples, the parameters may include a phase of the multiple subcarriers 210, an amplitude of the multiple subcarriers 210, the symbol duration of the zero power device 205 (e.g., the backscatter forward link that may not preclude the backscatter link), or any combination thereof.

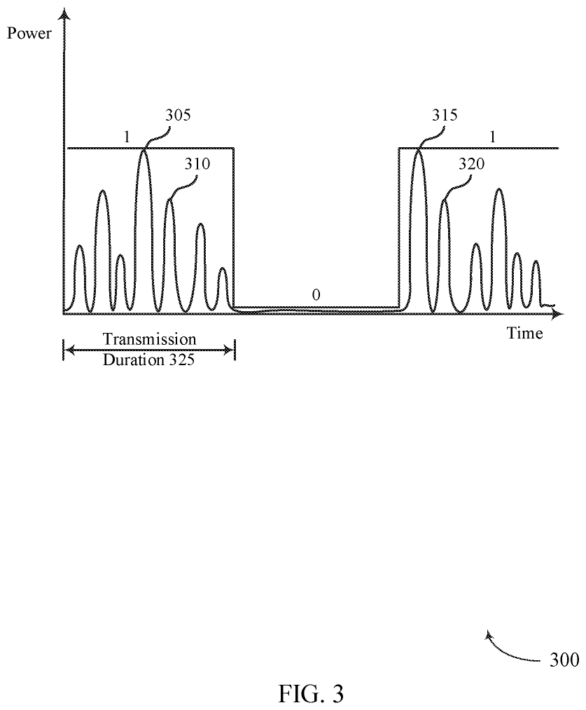

At 230, the UE 115-a may receive the control message 225, and may select one or more parameters for the continuous wave transmission 240 based on the SCS 260. In some cases, the UE 115-a may transmit the continuous wave transmission 240 to the zero power device 205 via a communication link 235 (e.g., a forward link). For example, the UE 115-a may transmit the continuous wave transmission 240 according to the one or more parameters and using a multiple-subcarrier waveform (e.g., using the multiple subcarriers 210). In some examples, the UE 115-a may modulate the continuous wave transmission 240 according to an ASK modulation scheme. In some implementations, ASK may be a form of amplitude modulation representing digital data (e.g., 1s and 0s, steps, binary) as variations of amplitude in the carrier wave. In some examples, ASK modulation shows the waveform as a series of bits being shifted repeatedly between high and low amplitudes. As such, the RFID systems may implement ASK modulation for forward link ASK and envelope detection, where a wireless device may use envelope detection to find amplitude variations of an incoming signal and to produce a control signal using the variations. As such, the UE 115-a may use ASK modulation for the waveforms in backscatter communication to provide stable voltage and power in RF communication. For example, ASK modulation may involve square waveforms with digital on and off states, which show distinct time periods of steady communication. That is, the continuous wave transmission 240 may be ASK modulated with a set of commands, which is described in further detail with respect to FIG. 3.

The zero power device 205 may receive the continuous wave transmission 240, and power up and/or send signaling 250 to the UE 115-a. The continuous wave transmission may include a set of commands for the zero power device 205. In some aspects, the information transmitted between the UE 115-a and the zero power device 205 may be sent using a pulse position modulation (PPM) scheme, which may provide for increased transmission throughput (e.g., multiple bits per symbol). The zero power device 205 may reflect, or transmit, the signaling 250 to the UE 115-a, or any other device in the wireless communications system 200. The signaling 250 may be in accordance with and in response to the set of commands from the UE 115-a.

In some examples, the zero power device 205 may include both passive and active components. For example, the zero power device 205 may include one or more passive tags with passive components. In some instances, the zero power device 205 may include semi-passive tags with both active and passive components. In some aspects, the zero power device 205 may establish a communication link 245 with the UE 115-a. In some examples, the zero power device 205 may send the signaling 250 in response to the continuous wave transmission 240. As such, in NR systems, the UE 115-a may use backscatter communication techniques to activate and communicate with the zero power device 205 via the continuous wave transmission 240 with the multiple subcarriers 210. Backscatter communications transmitted via the multiple subcarriers 210 may be modulated in accordance with an ASK modulation scheme in forward link communication.

FIG. 3 illustrates an example of a transmission diagram 300 that supports a multiple-subcarrier waveform for backscatter communications in accordance with one or more aspects of the present disclosure. The transmission diagram 300 may be implemented by aspects of the wireless communications system 100 and 200. For example, the transmission diagram 300 may be implemented by a UE 115, a zero power device 205, a network entity 105, or any combination thereof, as described with reference to FIGS. 1 and 2.

In some implementations, a network entity may select a symbol duration (e.g., an OFDM symbol) of a continuous wave transmission, where a UE may perform the continuous wave transmission to activate and/or communicate with a zero power device, as described with reference to FIG. 2. The symbol duration may be a time period over which the UE may transmit signaling (e.g., the continuous wave transmission). For some waveforms, a symbol duration may be flexible. For example, in RFID systems, a network entity may dynamically configure the symbol duration, such as by transmitting control signaling (e.g., a DCI message, a MAC-CE, or other dynamic signaling). In some cases, the symbol duration may be between 6.25 μs and 25 μs.

Additionally, or alternatively, the network entity may indicate parameters of the multiple-subcarrier waveforms by indicating an SCS to one or more UEs. In some examples, the multiple-subcarrier waveform may repeatedly occur every I/SCS seconds. For example, if the SCS is 15 kilohertz (kHz) then 1/SCS may be 66.6 μs. However, if the zero power device has a baseband symbol duration shorter than 1/SCS seconds, one or more wireless devices (e.g., the zero power device, the UE, or both) may be unable to communicate using the multi-subcarrier waveform, where a baseband symbol may refer to a symbol duration for communications using an original frequency range of a transmission signal before the signal is modulated. In some aspects, the UE may apply an ASK modulation scheme to the continuous wave transmission, which may provide for a baseband symbol duration to be greater than or equal to 1/SCS seconds. In some examples, multiple subcarriers may each have a same phase. For example, subcarriers with a same phase may have a 480 kHz carrier frequency based on calculations using a carrier wave frequency of 900 MHZ, an inverse of the carrier wave frequency of 1.1 nanoseconds (ns), a SCS of 15 kHz, and 32 REs. In some cases, the multiple subcarriers may be spaced in the time domain (e.g., may have a symbol duration) based on the SCS. For example, a UE may transmit a continuous wave transmission according to an ASK modulation scheme with a forward link symbol duration directly proportional to 1/SCS. For instance, the symbol duration may be equal to double the inverse of the SCS (e.g., 2/SCS), or the symbol duration may be 3/SCS, 4/SCS, or some other multiple of 1/SCS. In some other examples, the symbol duration (e.g., a forward link symbol duration), may be based on the inverse of a multiple of the SCS, such as 1/SCS, ½SCS, ⅓SCS, or the like.

In examples where the UE uses the inverse of the SCS (1/SCS) for the symbol duration of backscatter communications, the symbol duration may only provide for the UE to transmit one (or fewer) bits of information within a symbol period. Thus, the UE may modify the phase of the subcarriers, such that the UE may transmit a full bit of information in a symbol having a duration corresponding to the inverse of the SCS duration. For example, the UE may use PPM to adjust (e.g., change, modify) the phase of the multiple subcarriers used for the continuous wave transmission. In some examples, PPM may provide for signal modulation of message bits that may be encoded when transmitting a single pulse in one or more time shifts. To change the phase, the PPM may be applied with a linear phase ramp that produces a frequency shift. To accommodate compatibility of a multiple-subcarrier waveform (e.g., in an NR system), the UE may use the PPM for a continuous wave transmission to zero power devices. For example, for a subcarrier, i, with a carrier frequency (e.g., 480 kHz), the phase of the subcarrier i may be 2π*i*⅝. In some instances, the UE may use different positions, or phases, to carry information that exceeds 1 bit.

In some implementations, a peak-to-average-power ratio (PAPR) may increase when the phase of multiple subcarriers is changed. The PAPR may represent a relationship between the maximum power in an OFDM symbol divided by the average power of the OFDM symbol. That is, the PAPR may be the ratio of peak power to average power of a signal, which may be represented in decibels (dB). In some instances, the PAPR may be relatively high when multiple different subcarriers have a same phase. When the PAPR is relatively high, one or more zero power devices (e.g., passive tags) may discharge at a higher rate (e.g., due to an absence of incoming energy supplying power to the zero power devices IC, for example, via energy harvesting). In some cases, the zero power devices may have relatively increased power charging capacity to accommodate the relatively high PAPR: however, this may result in a relatively longer charge time and power up time. Further, the hardware of the zero power devices may not support the relatively high PAPR (e.g., the components of the zero power device may overheat, or may otherwise not support the high PAPR).

In some examples, as illustrated in the transmission diagram 300, one or more wireless devices may use a randomized phase, a randomized amplitude, or both to reduce PAPR (e.g., a lower power duration), while concurrently implementing the ASK modulation scheme. In some examples, the wireless devices (e.g., a UE) may introduce the randomized phase, the randomized amplitude, or both by varying one or more power levels of a continuous wave transmission using a multiple-subcarrier waveform. Varying the power levels of different subcarriers may reduce the difference between the maximum peak and the minimum peak over a time period, which may result in a decreased PAPR. For example, a peak 305, a peak 310, a peak 315, and a peak 320 may have different power amplitudes in dB. The UE may transmit the continuous wave transmission by varying the power for the 1/SCS duration, which may relay one bit of information (e.g., a 1 or a 0). The ASK modulation may be shown as a square wave with steps between bits 0 and 1 that relate to a power output of the UE, which demonstrates digital data for the continuous wave transmission using the multiple-subcarrier waveform. In some cases, the square wave may represent a bit value of 1 if the UE is transmitting the peaks or may represent a bit value of 0 if the UE refrains from outputting power. For example, the UE may output transmissions with the randomized phase, the randomized amplitude, or both or may transmit zero power (e.g., 0 dB) in accordance with the transmission duration 325 (e.g., 1/SCS). The transmission duration 325 may be dependent on SCS in the multiple-subcarrier waveform. In some examples, the network entity may indicate (e.g., via control signaling) for the UE to perform the randomized phase transmissions based on a PAPR value exceeding or being less than a threshold, where the threshold may be configured via control signaling or otherwise defined at the UE. Similarly, the network entity may configure one or more parameters including the randomized phase, an amplitude, or both to the UE.

In some cases, the UE may randomize the phase of the continuous wave transmission multiple waves according to a known sequence. For example, the UE may use a Zadoff Chu (ZC) sequence, where a signal may create (e.g., duplicate) another signal with a constant amplitude. In other examples, the UE may use a fast Fourier transform (FFT), a discrete Fourier transform (DFT), or both to convert signals from the original domain (e.g., in time or space) to a different representation in the frequency domain. The FFT and DFT methods may be performed at relatively high speeds. Additionally, or alternatively, an M-sequence may be utilized, where a feedback shift register may cycle through polynomials to create multiple phases of a same sequence. As such, the randomized phase and amplitude may be achieved by adding various peaks (e.g., the peak 305, the peak 310, the peak 315, and the peak 320) during the symbol duration. The UE may generate the peaks to realize the randomization. For example, the UE may adjust the peaks in the frequency domain, may add different linear phase ramps together, sum different peak positions in the transmission duration 325, or any combination thereof. In some instances, a relatively long symbol duration (e.g., for an SCS of 15 kHz) may lead to a relatively low data rate.

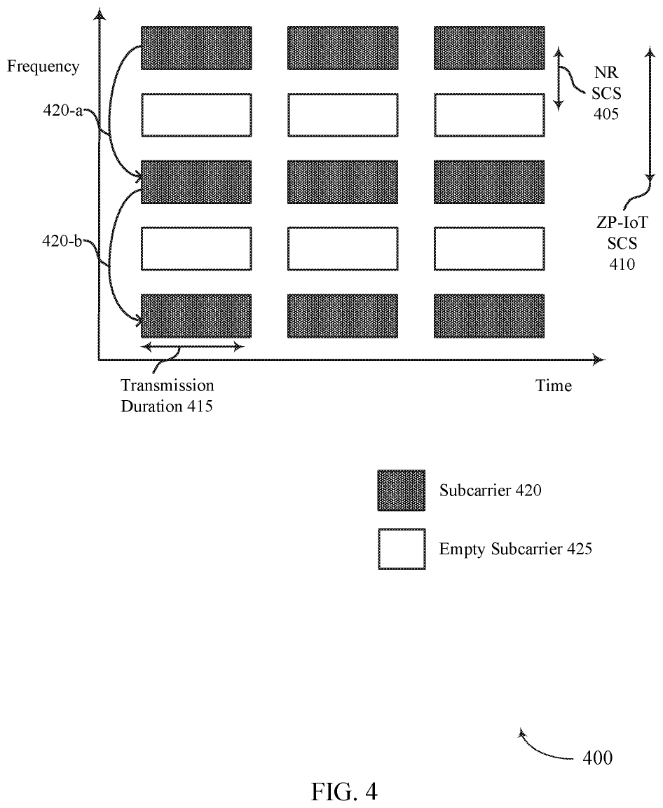

FIG. 4 illustrates an example of a transmission diagram 400 that supports a multiple-subcarrier waveform for backscatter communications in accordance with one or more aspects of the present disclosure. The transmission diagram 400 may implement or be implemented by aspects of the wireless communications system 100, 200, and the transmission diagram 300. For example, the transmission diagram 400 may be implemented by a UE 115, a zero power device 205, a network entity 105, or any combination thereof, as described with reference to FIGS. 1 and 2. The transmission diagram 400 may illustrate a spacing between subcarriers 420 that may be used for transmitting a backscatter signal that is compatible with, for example, an NR system.

In some examples, a network entity may transmit control signaling to a UE configuring a SCS for a multiple-subcarrier waveform. In some cases, a SCS in NR systems (e.g., NR SCS 405) may differ from a SCS in RFID systems, or zero-power IoT systems (e.g., ZP-IoT SCS 410). For example, in NR systems the SCS may be defined as 15 kHz, 30 kHz, 60 kHz, 120 kHz, or 240 kHz. However, the SCS for the RFID systems may be defined up to 300 KHz, which exceeds the frequencies for the NR SCS 405. In some examples, whether the SCS is contiguous in the frequency domain, or non-contiguous in the time domain, may depend on whether the UE is scheduled to transmit sounding reference signals (SRSs). For example, if the UE is scheduled to transmit one or more SRSs, the SCS may have a non-contiguous spacing (e.g., ZP-IoT SCS 410), such that the subcarriers may skip from a first frequency range to a different frequency range at 420-a and at 420-b. The non-contiguous subcarriers may result in a relatively lower PAPR for the system. Additionally, or alternatively, the SCS may be contiguous in the frequency domain (e.g., NR SCS 405), such that the subcarriers may not skip from a first frequency range to a different frequency range.

In some aspects, one or more wireless devices (e.g., a UE or a network entity) may transmit one subcarrier, or tone, every K subcarriers. For example, if K is equal to 2, as illustrated in transmission diagram 400, a UE may transmit a continuous wave transmission using every other subcarrier at 420-a and at 420-b, such that every other subcarrier is an empty subcarrier 425 (e.g., with no transmission or signaling). The UE may skip subcarriers at 420-a and at 420-b for the continuous wave transmission. The value of K may be configured at the UE. For example, a network entity may transmit the value of K to the UE in control signaling (e.g., RRC signaling, a MAC-CE, a DCI message, or the like).

In some cases, a carrier waveform may be a sinusoidal waveform of the multiple subcarriers in a multiple-subcarrier waveform, where each peak of a subcarrier is shown as power over time. The peaks of the multiple subcarriers may be separated by the symbol duration that occurs between each subcarrier, such as a transmission duration 415. For the multiple subcarriers in NR systems, the transmission duration 415, which may also be a symbol duration, may extend for 1/SCS seconds in the time domain. The UE may transmit the continuous wave transmission via the subcarriers according to the ZP-IoT SCS 410, such as by modulating the wave using an ASK modulation scheme.

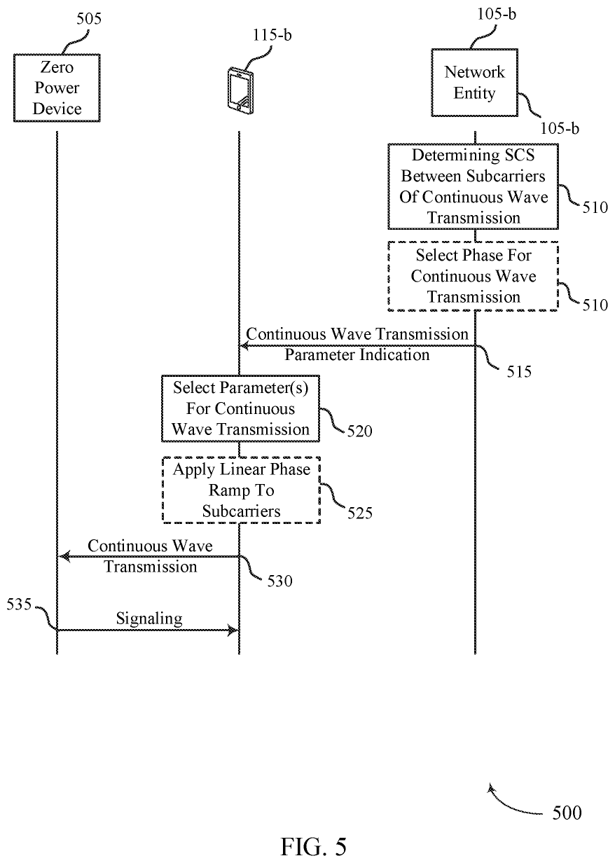

FIG. 5 illustrates an example of a process flow 500 in a system that supports a multiple-subcarrier waveform for backscatter communications in accordance with one or more aspects of the present disclosure. In some examples, the process flow 500 may implement or be implemented by aspects of the wireless communications systems 100, wireless communications system 200, transmission diagram 300, and transmission diagram 400, as described with reference to FIGS. 1-4. For example, the process flow 500 illustrates communications between a network entity 105-b, a UE 115-b, and a zero power device 505 which may represent examples of corresponding devices described with reference to FIGS. 1-4. In some aspects, the UE 115-b may support activation of and/or communication with the zero power device 505.

In the following description of the process flow 500, the operations between the UE 115-b and the network entity 105-b may be performed in different orders or at different times. Some operations may also be left out of the process flow 500, or other operations may be added. Although the UE 115-b and the network entity 105-b are shown performing the operations of the process flow 500, some aspects of some operations may also be performed by one or more other wireless devices. For example, the network entity 105-b may activate the zero power device 505, communicate with the zero power device 505, or both (e.g., in addition to or instead of the UE 115-b). The zero power device, which may be referred to as a passive device, may include passive components, active components, or both.

At 510, the network entity 105-b may determine a SCS between multiple subcarriers of a continuous wave transmission. For example, as described with reference to FIG. 4, the network entity 105-b may select a zero-power IoT SCS, an NR SCS, or both representing a frequency spacing between subcarriers in a multiple subcarrier (e.g., multi-subcarrier) waveform transmission. The SCS be non-contiguous, such that the UE 115-b transmits a tone every K subcarriers, or the SCS may be contiguous.

At 515, the network entity 105-b may select a phase for a continuous wave transmission from the UE 115-b to the zero power device 505. The network entity 105-b may select the phase based on a PAPR being below a threshold value, where the network entity 105-b may configure the threshold value. For example, the network entity 105-b may determine a randomized phase using a sequence (e.g., a ZC sequence, a FFT, a DFT, an M-sequence, or the like). Additionally, or alternatively, the network entity 105-b may select a symbol duration for the continuous wave transmission based on 1/SCS.

At 520, the network entity 105-b may transmit, and the UE 115-b may receive, a control message indicating one or more parameters of the continuous wave transmission to the UE 115-b. For example, the network entity 105-b may transmit a configuration of the SCS, where a symbol duration of the continuous wave transmission is based on the SCS. In some other examples, the network entity 105-b may transmit a configuration of a symbol duration of the continuous wave transmission, where the SCS is based on the symbol duration. In some cases, the control message may indicate a configuration for generating a phase for the continuous wave transmission at the UE 115-b. The one or more parameters may include a phase of the subcarriers, an amplitude of the subcarriers, a symbol duration of the continuous wave transmission, or any combination thereof.

At 520, the UE 115-b may select one or more parameters for the continuous wave transmission using a multiple-subcarrier waveform. For example, the UE 115-b may select one or more parameters for the continuous wave transmission to activate the zero power device 505, to communicate with the zero power device 505, or both. The one or more parameters may be based on a SCS between each subcarrier of multiple subcarriers.

In some cases, the UE 115-b may select a phase, an amplitude, or both for the continuous wave transmission based on a value of a PAPR being below a threshold value. The network entity 105-a may configure the threshold value at the UE 115-b, or the threshold value may be otherwise defined at the UE 115-b. The one or more parameters may include the phase, the amplitude, or both, where the UE 115-a applies the phase to the continuous wave transmission for activating and communicating with the zero power device 505. In some examples, the UE 115-b may receive a message (e.g., from the network entity 105-b) indicating a configuration for generating the phase, the amplitude, or both for the continuous wave transmission. The UE 115-b may select the phase based on the configuration. In some cases, the phase, the amplitude, or both may be randomized, such that the UE 115-b may determine the randomized phase or amplitude based on a ZC sequence, a FFT, a DFT, an M-sequence, or any combination thereof.

In some examples, the UE 115-b may select a symbol duration of the continuous wave transmission on an inverse of a multiple of the SCS (1/SCS, ½SCS, ⅓SCS etc.), where the one or more parameters includes the symbol duration. In some examples, the UE 115-b may receive a message (e.g., from the network entity 105-b) indicating a configuration of the SCS, where the one or more parameters are selected based on the configuration, and where a symbol duration of the continuous wave transmission is based on the subcarrier spacing. Additionally, or alternatively, the UE 115-b may receive a message indicating a configuration of a symbol duration of the continuous wave transmission, where the one or more parameters are selected based on the configuration, and where the SCS is based at least in part on the symbol duration. In some examples, at 525, the UE 115-b may apply the linear phase ramp to one or more subcarriers to shift the continuous wave transmission in a time domain.

At 530, the UE 115-b may transmit, and the zero power device may receive, the continuous wave transmission to the zero power device 505 in accordance with the selected parameters and via the subcarriers. In some examples, the UE 115-b may modulate at least a portion of the continuous wave transmission in accordance with an ASK modulation scheme. For example, the UE 115-b may modulate the continuous wave transmission using the ASK modulation scheme. The continuous wave transmission may include a set of commands for the zero power device 505. In some cases, the set of commands may include information modulated in accordance with a PPM scheme that is based on applying the linear phase ramp to shift the continuous wave transmission.

At 535, the zero power device 505 may transmit signaling back to the UE 115-b in response to the continuous wave transmission received at 530.

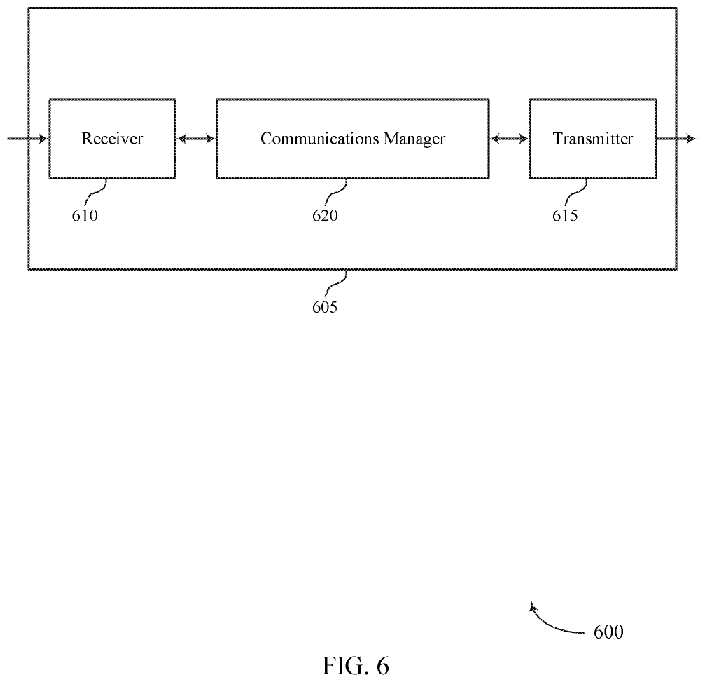

FIG. 6 shows a block diagram 600 of a device 605 that supports a multiple-subcarrier waveform for backscatter communications in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to a multiple-subcarrier waveform for backscatter communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to a multiple-subcarrier waveform for backscatter communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of a multiple-subcarrier waveform for backscatter communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for selecting, for activating and communicating with a zero power device, one or more parameters of a continuous wave transmission associated with a set of multiple subcarriers, the one or more parameters being based on a SCS between each subcarrier of the set of multiple subcarriers. The communications manager 620 may be configured as or otherwise support a means for transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The communications manager 620 may be configured as or otherwise support a means for receiving, from the zero power device, signaling responsive to the continuous wave transmission and the set of commands.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a UE to select parameters of a continuous wave transmission with at least a portion modulated according to an ASK modulation scheme for communicating and activating a zero power device (e.g., passive device) using multiple subcarriers, which may provide for reduced processing, reduced power consumption, more efficient utilization of communication resources, and the like.

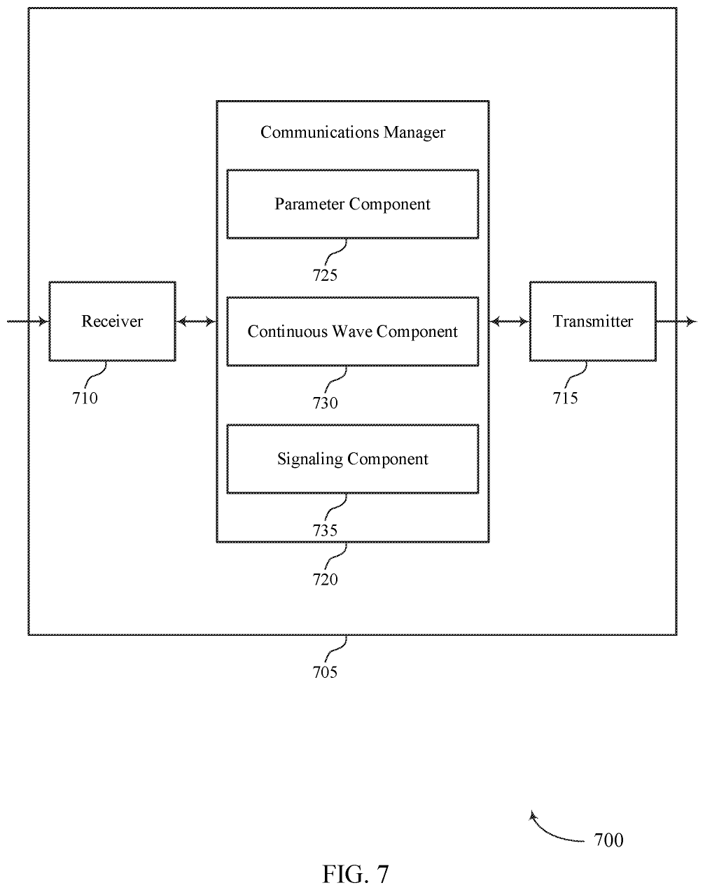

FIG. 7 shows a block diagram 700 of a device 705 that supports a multiple-subcarrier waveform for backscatter communications in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to a multiple-subcarrier waveform for backscatter communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to a multiple-subcarrier waveform for backscatter communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of a multiple-subcarrier waveform for backscatter communications as described herein. For example, the communications manager 720 may include a parameter component 725, a continuous wave component 730, a signaling component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The parameter component 725 may be configured as or otherwise support a means for selecting, for activating and communicating with a zero power device, one or more parameters of a continuous wave transmission associated with a set of multiple subcarriers, the one or more parameters being based on a SCS between each subcarrier of the set of multiple subcarriers. The continuous wave component 730 may be configured as or otherwise support a means for transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The signaling component 735 may be configured as or otherwise support a means for receiving, from the zero power device, signaling responsive to the continuous wave transmission and the set of commands.

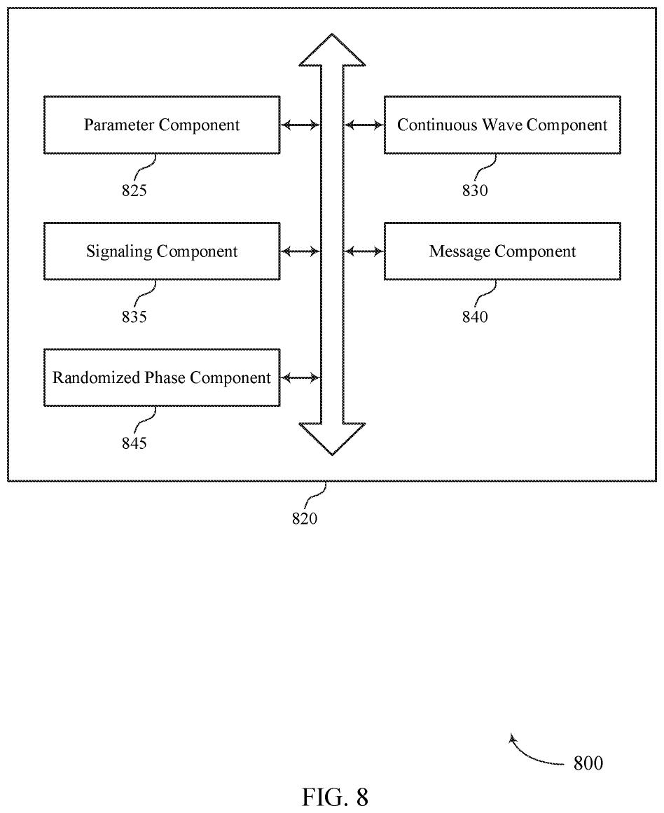

FIG. 8 shows a block diagram 800 of a communications manager 820 that supports a multiple-subcarrier waveform for backscatter communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of a multiple-subcarrier waveform for backscatter communications as described herein. For example, the communications manager 820 may include a parameter component 825, a continuous wave component 830, a signaling component 835, a message component 840, a randomized phase component 845, or any combination thereof. Each of these components may communicate, directly or indirectly, with one another (e.g., via one or more buses).

The communications manager 820 may support wireless communication at a UE in accordance with examples as disclosed herein. The parameter component 825 may be configured as or otherwise support a means for selecting, for activating and communicating with a zero power device, one or more parameters of a continuous wave transmission associated with a set of multiple subcarriers, the one or more parameters being based on a SCS between each subcarrier of the set of multiple subcarriers. The continuous wave component 830 may be configured as or otherwise support a means for transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The signaling component 835 may be configured as or otherwise support a means for receiving, from the zero power device, signaling responsive to the continuous wave transmission and the set of commands.

In some examples, to support selecting the one or more parameters, the parameter component 825 may be configured as or otherwise support a means for selecting a phase, an amplitude, or both for the continuous wave transmission based on a value of a PAPR ratio being below a threshold value, the one or more parameters including the phase, the amplitude, or both, where the phase, the amplitude, or both is applied to the continuous wave transmission for activating and communicating with the zero power device.

In some examples, the message component 840 may be configured as or otherwise support a means for receiving a message indicating a configuration for generating the phase, the amplitude, or both for the continuous wave transmission, where the phase, the amplitude, or both is selected based on the configuration.

In some examples, the phase is a randomized phase, the amplitude is a randomized amplitude, or both, and the randomized phase component 845 may be configured as or otherwise support a means for determining the randomized phase, the randomized amplitude, or both based on a ZC sequence, or an FFT, or a DFT, or any combination thereof.

In some examples, to support selecting the one or more parameters, the parameter component 825 may be configured as or otherwise support a means for selecting a symbol duration of the continuous wave transmission based on an inverse of a multiple of the SCS, where the one or more parameters include the symbol duration.

In some examples, the continuous wave component 830 may be configured as or otherwise support a means for applying a linear phase ramp to one or more subcarriers of the set of multiple subcarriers to shift the continuous wave transmission in a time domain, where the set of commands includes information modulated in accordance with a PPM scheme that is based on the shifted continuous wave transmission.

In some examples, the parameter component 825 may be configured as or otherwise support a means for receiving a message indicating a configuration of the SCS, where the one or more parameters are selected based on the configuration, and where a symbol duration of the continuous wave transmission is based on the SCS.

In some examples, the parameter component 825 may be configured as or otherwise support a means for receiving a message indicating a configuration of a symbol duration of the continuous wave transmission, where the one or more parameters are selected based on the configuration, and where the SCS is based on the symbol duration.

In some examples, respective subcarriers of the set of multiple subcarriers are non-contiguous in a frequency domain based on the SCS.

In some examples, the one or more parameters include a phase associated with the set of multiple subcarriers, an amplitude associated with the set of multiple subcarriers, a symbol duration of the continuous wave transmission, or any combination thereof.

In some examples, the continuous wave component 830 may be configured as or otherwise support a means for modulating the continuous wave transmission using the ASK modulation scheme.

In some examples, the zero power device includes passive components or active components, or both.

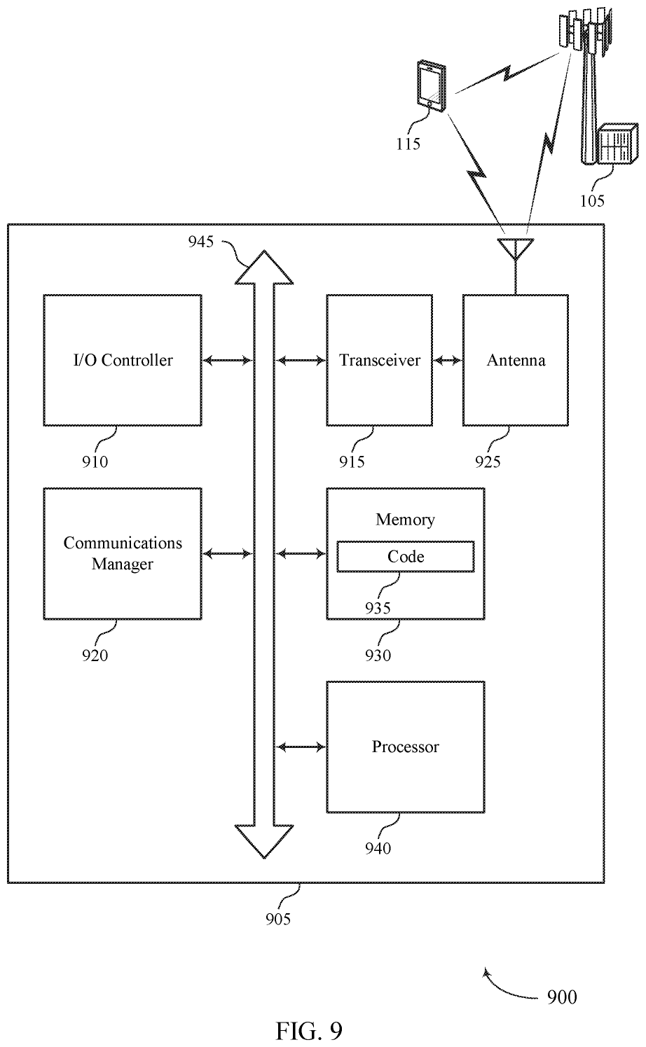

FIG. 9 shows a diagram of a system 900 including a device 905 that supports a multiple-subcarrier waveform for backscatter communications in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting a multiple-subcarrier waveform for backscatter communications). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for selecting, for activating and communicating with a zero power device, one or more parameters of a continuous wave transmission associated with a set of multiple subcarriers, the one or more parameters being based on a SCS between each subcarrier of the set of multiple subcarriers. The communications manager 920 may be configured as or otherwise support a means for transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The communications manager 920 may be configured as or otherwise support a means for receiving, from the zero power device, signaling responsive to the continuous wave transmission and the set of commands.

By including or configuring the communications manager 920 in accordance with examples as described herein, the device 905 may support techniques for a UE to select parameters of a continuous wave transmission with at least a portion modulated according to an ASK modulation scheme for communicating and activating a zero power device (e.g., passive device) using multiple subcarriers, which may provide for improved communication reliability, reduced latency, improved user experience related to reduced processing, reduced power consumption, more efficient utilization of communication resources, improved coordination between devices, longer battery life, improved utilization of processing capability, or the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of a multiple-subcarrier waveform for backscatter communications as described herein, or the processor 940 and the memory 930 may be otherwise configured to perform or support such operations.

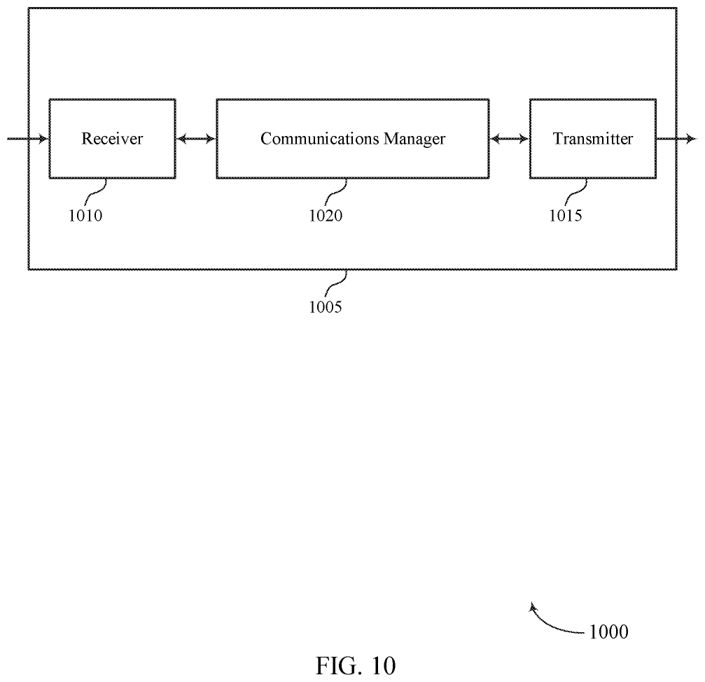

FIG. 10 shows a block diagram 1000 of a device 1005 that supports a multiple-subcarrier waveform for backscatter communications in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of a multiple-subcarrier waveform for backscatter communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for determining a SCS between a set of multiple subcarriers of a continuous wave transmission for a UE to activate and communicate with a zero power device. The communications manager 1020 may be configured as or otherwise support a means for transmitting a control message indicating one or more parameters of the continuous wave transmission, the one or more parameters being based on the SCS.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for a UE to select parameters of a continuous wave transmission with at least a portion modulated according to an ASK modulation scheme for communicating or activating a zero power device (e.g., passive device) using multiple subcarriers, which may provide for reduced processing, reduced power consumption, more efficient utilization of communication resources, and the like.

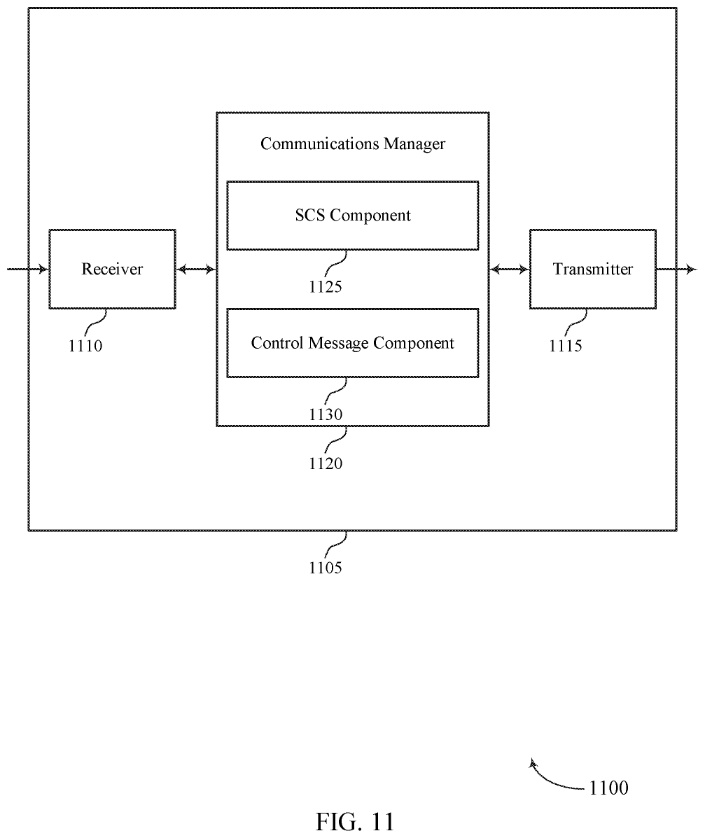

FIG. 11 shows a block diagram 1100 of a device 1105 that supports a multiple-subcarrier waveform for backscatter communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of a multiple-subcarrier waveform for backscatter communications as described herein. For example, the communications manager 1120 may include an SCS component 1125 a control message component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The SCS component 1125 may be configured as or otherwise support a means for determining a SCS between a set of multiple subcarriers of a continuous wave transmission for a UE to activate and communicate with a zero power device. The control message component 1130 may be configured as or otherwise support a means for transmitting a control message indicating one or more parameters of the continuous wave transmission, the one or more parameters being based on the SCS.

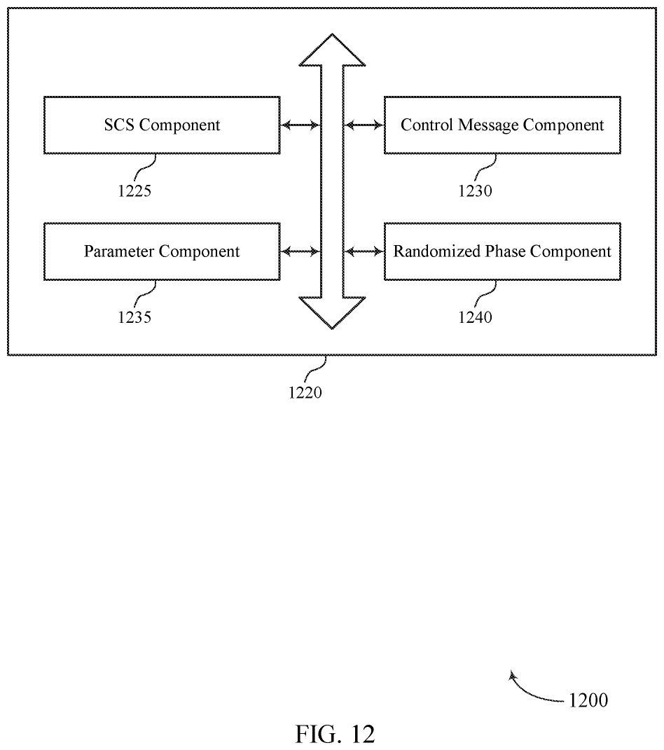

FIG. 12 shows a block diagram 1200 of a communications manager 1220 that supports a multiple-subcarrier waveform for backscatter communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of a multiple-subcarrier waveform for backscatter communications as described herein. For example, the communications manager 1220 may include an SCS component 1225, a control message component 1230, a parameter component 1235, a randomized phase component 1240, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The SCS component 1225 may be configured as or otherwise support a means for determining a SCS between a set of multiple subcarriers of a continuous wave transmission for a UE to activate and communicate with a zero power device. The control message component 1230 may be configured as or otherwise support a means for transmitting a control message indicating one or more parameters of the continuous wave transmission, the one or more parameters being based on the SCS.

In some examples, to support transmitting the control message, the control message component 1230 may be configured as or otherwise support a means for transmitting the control message that indicates a configuration for generating a phase for the continuous wave transmission.

In some examples, the parameter component 1235 may be configured as or otherwise support a means for selecting a phase, an amplitude, or both for the continuous wave transmission based on a value of a PAPR ratio being below a threshold value, the one or more parameters including the phase.

In some examples, the phase is a randomized phase, the amplitude is a randomized amplitude, or both, and the randomized phase component 1240 may be configured as or otherwise support a means for determining the randomized phase, the randomized amplitude, or both based on a ZC sequence, or an FFT, or a DFT, or an M-sequence, or any combination thereof.

In some examples, the parameter component 1235 may be configured as or otherwise support a means for selecting a symbol duration of the continuous wave transmission based on an inverse of a multiple of the SCS, where the one or more parameters include the symbol duration.

In some examples, to support transmitting the control message, the control message component 1230 may be configured as or otherwise support a means for transmitting the control message indicating a configuration of the SCS, where a symbol duration of the continuous wave transmission is based on the SCS.

In some examples, to support transmitting the control message, the control message component 1230 may be configured as or otherwise support a means for transmitting the control message indicating a configuration of a symbol duration of the continuous wave transmission, where the SCS is based on the symbol duration.

In some examples, respective subcarriers of the set of multiple subcarriers are non-contiguous in a frequency domain based on the SCS.

In some examples, the one or more parameters include a phase associated with the set of multiple subcarriers, an amplitude associated with the set of multiple subcarriers, a symbol duration of the continuous wave transmission, or any combination thereof.

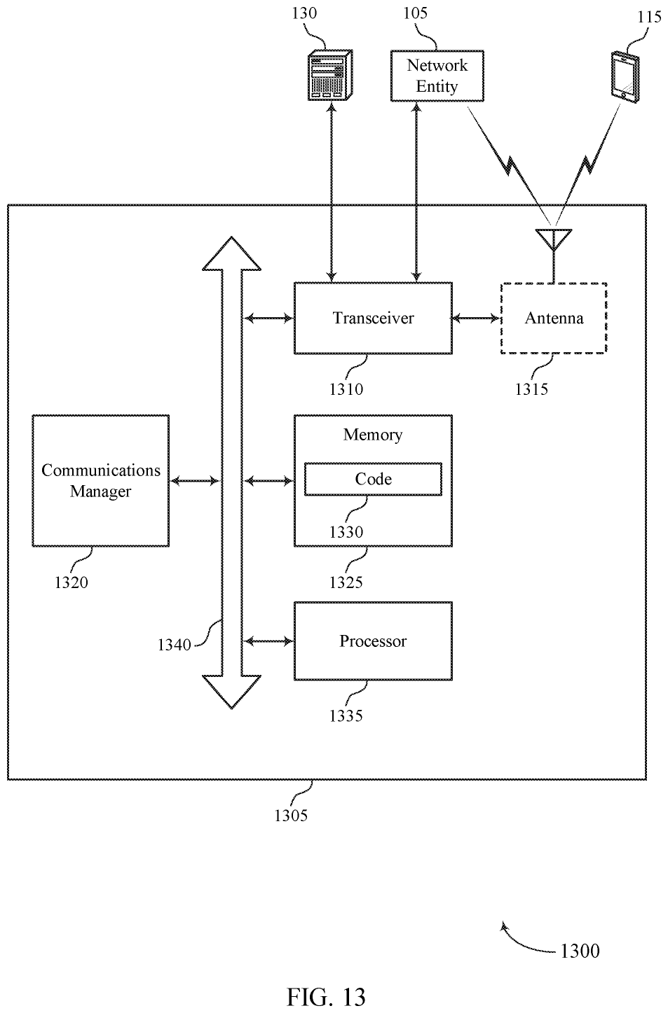

FIG. 13 shows a diagram of a system 1300 including a device 1305 that supports a multiple-subcarrier waveform for backscatter communications in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting a multiple-subcarrier waveform for backscatter communications). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for determining a SCS between a set of multiple subcarriers of a continuous wave transmission for a UE to activate and communicate with a zero power device. The communications manager 1320 may be configured as or otherwise support a means for transmitting a control message indicating one or more parameters of the continuous wave transmission, the one or more parameters being based on the SCS.

By including or configuring the communications manager 1320 in accordance with examples as described herein, the device 1305 may support techniques for a UE to select parameters of a continuous wave transmission with at least a portion modulated according to an ASK modulation scheme for communicating or activating a zero power device (e.g., passive device) using multiple subcarriers, which may provide for improved communication reliability, reduced latency, improved user experience related to reduced processing, reduced power consumption, more efficient utilization of communication resources, improved coordination between devices, longer battery life, improved utilization of processing capability, or the like.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of a multiple-subcarrier waveform for backscatter communications as described herein, or the processor 1335 and the memory 1325 may be otherwise configured to perform or support such operations.

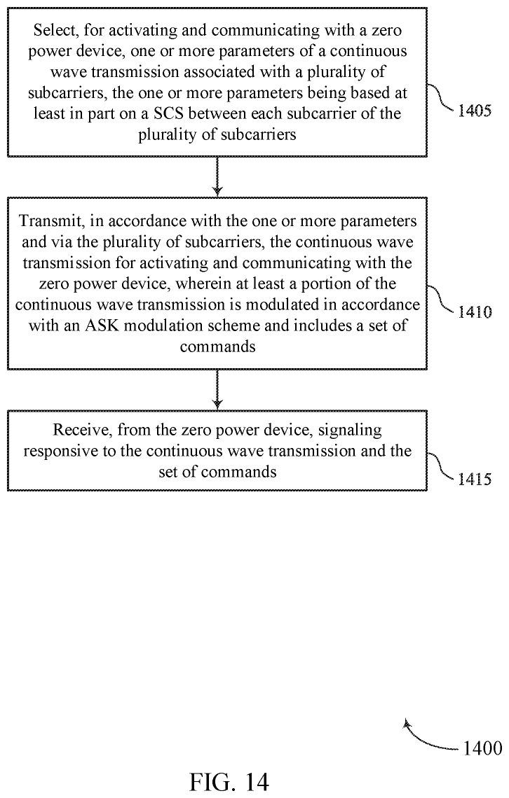

FIG. 14 shows a flowchart illustrating a method 1400 that supports a multiple-subcarrier waveform for backscatter communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include selecting, for activating and communicating with a zero power device, one or more parameters of a continuous wave transmission associated with a set of multiple subcarriers, the one or more parameters being based on a SCS between each subcarrier of the set of multiple subcarriers. The operations of 1405 may be performed in accordance with examples as disclosed herein. In some examples, aspects of the operations of 1405 may be performed by a parameter component 825 as described with reference to FIG. 8.

At 1410, the method may include transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The operations of 1410 may be performed in accordance with examples as disclosed herein. In some examples, aspects of the operations of 1410 may be performed by a continuous wave component 830 as described with reference to FIG. 8.

At 1415, the method may include receiving, from the zero power device, signaling responsive to the continuous wave transmission and the set of commands. The operations of 1415 may be performed in accordance with examples as disclosed herein. In some examples, aspects of the operations of 1415 may be performed by a signaling component 835 as described with reference to FIG. 8.

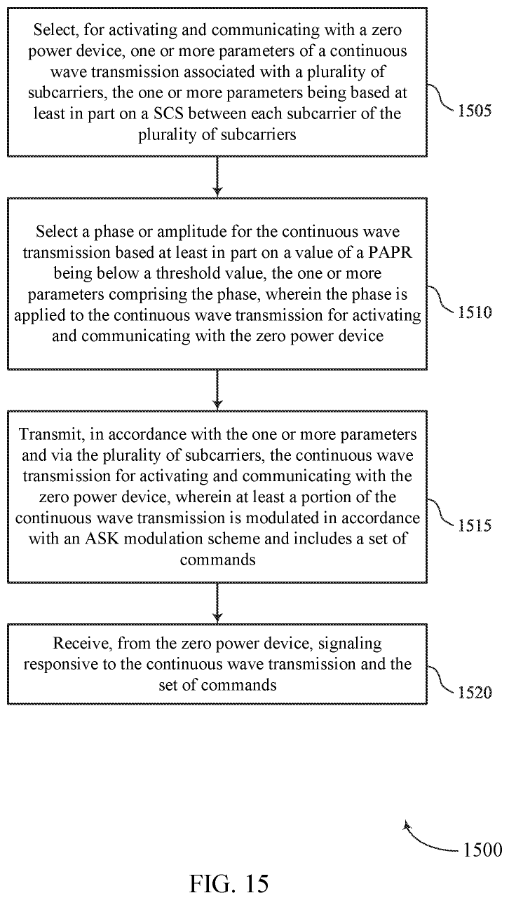

FIG. 15 shows a flowchart illustrating a method 1500 that supports a multiple-subcarrier waveform for backscatter communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include selecting, for activating and communicating with a zero power device, one or more parameters of a continuous wave transmission associated with a set of multiple subcarriers, the one or more parameters being based on a SCS between each subcarrier of the set of multiple subcarriers. The operations of 1505 may be performed in accordance with examples as disclosed herein. In some examples, aspects of the operations of 1505 may be performed by a parameter component 825 as described with reference to FIG. 8.

At 1510, the method may include selecting a phase, an amplitude, or both for the continuous wave transmission based on a value of a PAPR ratio being below a threshold value, the one or more parameters including the phase, the amplitude, or both, where the phase, the amplitude, or both is applied to the continuous wave transmission for activating and communicating with the zero power device. The operations of 1510 may be performed in accordance with examples as disclosed herein. In some examples, aspects of the operations of 1510 may be performed by a parameter component 825 as described with reference to FIG. 8.

At 1515, the method may include transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The operations of 1515 may be performed in accordance with examples as disclosed herein. In some examples, aspects of the operations of 1515 may be performed by a continuous wave component 830 as described with reference to FIG. 8.

At 1520, the method may include receiving, from the zero power device, signaling responsive to the continuous wave transmission and the set of commands. The operations of 1520 may be performed in accordance with examples as disclosed herein. In some examples, aspects of the operations of 1520 may be performed by a signaling component 835 as described with reference to FIG. 8.

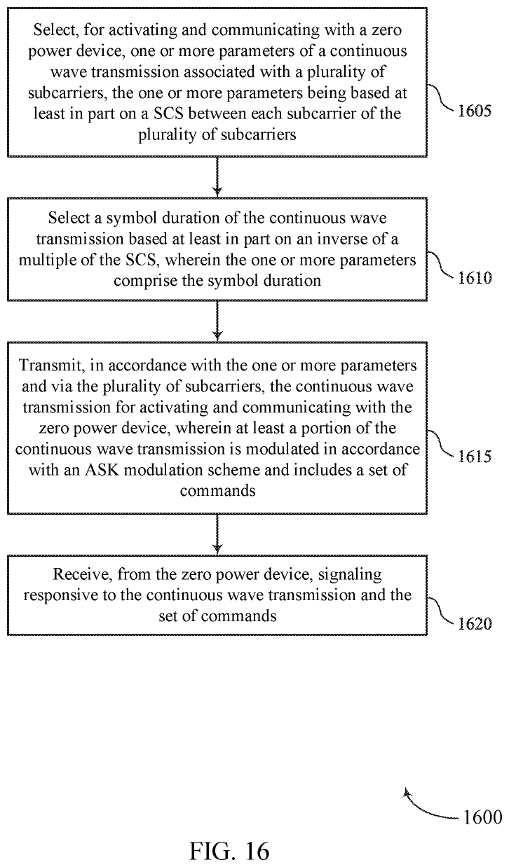

FIG. 16 shows a flowchart illustrating a method 1600 that supports a multiple-subcarrier waveform for backscatter communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include selecting, for activating and communicating with a zero power device, one or more parameters of a continuous wave transmission associated with a set of multiple subcarriers, the one or more parameters being based on a SCS between each subcarrier of the set of multiple subcarriers. The operations of 1605 may be performed in accordance with examples as disclosed herein. In some examples, aspects of the operations of 1605 may be performed by a parameter component 825 as described with reference to FIG. 8.

At 1610, the method may include selecting a symbol duration of the continuous wave transmission based on an inverse of a multiple of the SCS, where the one or more parameters include the symbol duration. The operations of 1610 may be performed in accordance with examples as disclosed herein. In some examples, aspects of the operations of 1610 may be performed by a parameter component 825 as described with reference to FIG. 8.

At 1615, the method may include transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The operations of 1615 may be performed in accordance with examples as disclosed herein. In some examples, aspects of the operations of 1615 may be performed by a continuous wave component 830 as described with reference to FIG. 8.

At 1620, the method may include receiving, from the zero power device, signaling responsive to the continuous wave transmission and the set of commands. The operations of 1620 may be performed in accordance with examples as disclosed herein. In some examples, aspects of the operations of 1620 may be performed by a signaling component 835 as described with reference to FIG. 8.

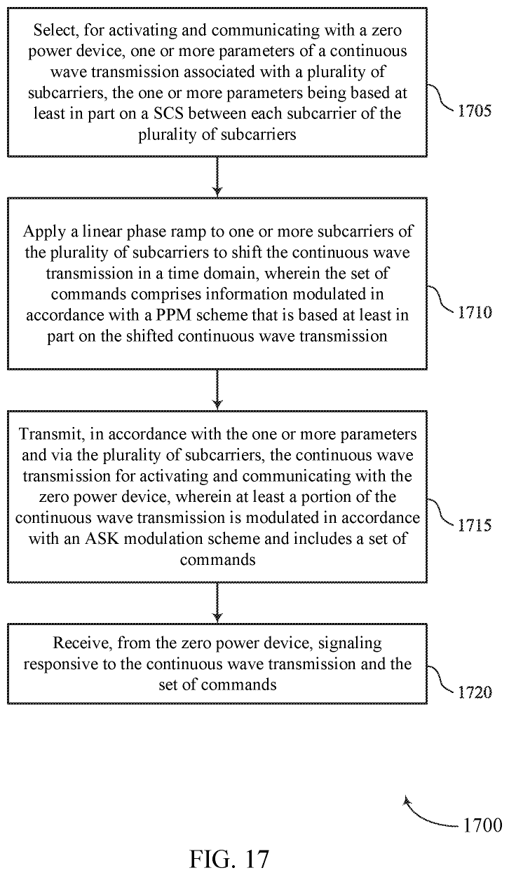

FIG. 17 shows a flowchart illustrating a method 1700 that supports a multiple-subcarrier waveform for backscatter communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include selecting, for activating and communicating with a zero power device, one or more parameters of a continuous wave transmission associated with a set of multiple subcarriers, the one or more parameters being based on a SCS between each subcarrier of the set of multiple subcarriers. The operations of 1705 may be performed in accordance with examples as disclosed herein. In some examples, aspects of the operations of 1705 may be performed by a parameter component 825 as described with reference to FIG. 8.

At 1710, the method may include applying a linear phase ramp to one or more subcarriers of the set of multiple subcarriers to shift the continuous wave transmission in a time domain, where the set of commands includes information modulated in accordance with a PPM scheme that is based on the shifted continuous wave transmission. The operations of 1710 may be performed in accordance with examples as disclosed herein. In some examples, aspects of the operations of 1710 may be performed by a continuous wave component 830 as described with reference to FIG. 8.

At 1715, the method may include transmitting, in accordance with the one or more parameters and via the set of multiple subcarriers, the continuous wave transmission for activating and communicating with the zero power device, where at least a portion of the continuous wave transmission is modulated in accordance with an ASK modulation scheme and includes a set of commands. The operations of 1715 may be performed in accordance with examples as disclosed herein. In some examples, aspects of the operations of 1715 may be performed by a continuous wave component 830 as described with reference to FIG. 8.

At 1720, the method may include receiving, from the zero power device, signaling responsive to the continuous wave transmission and the set of commands. The operations of 1720 may be performed in accordance with examples as disclosed herein. In some examples, aspects of the operations of 1720 may be performed by a signaling component 835 as described with reference to FIG. 8.

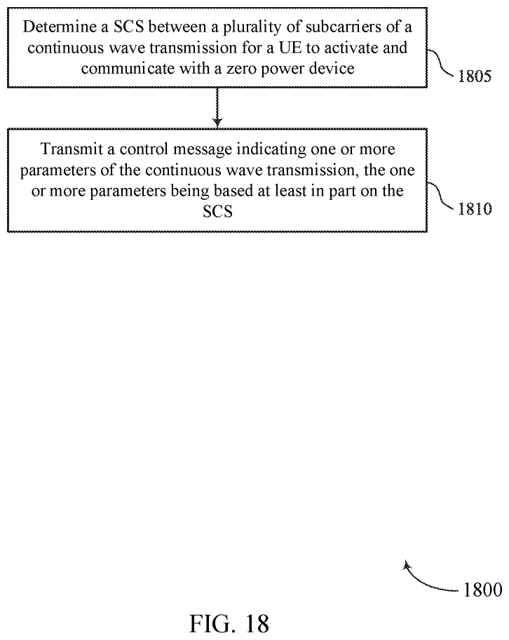

FIG. 18 shows a flowchart illustrating a method 1800 that supports a multiple-subcarrier waveform for backscatter communications in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include determining a SCS between a set of multiple subcarriers of a continuous wave transmission for a UE to activate and communicate with a zero power device. The operations of 1805 may be performed in accordance with examples as disclosed herein. In some examples, aspects of the operations of 1805 may be performed by an SCS component 1225 as described with reference to FIG. 12.

At 1810, the method may include transmitting a control message indicating one or more parameters of the continuous wave transmission, the one or more parameters being based on the SCS. The operations of 1810 may be performed in accordance with examples as disclosed herein. In some examples, aspects of the operations of 1810 may be performed by a control message component 1230 as described with reference to FIG. 12.

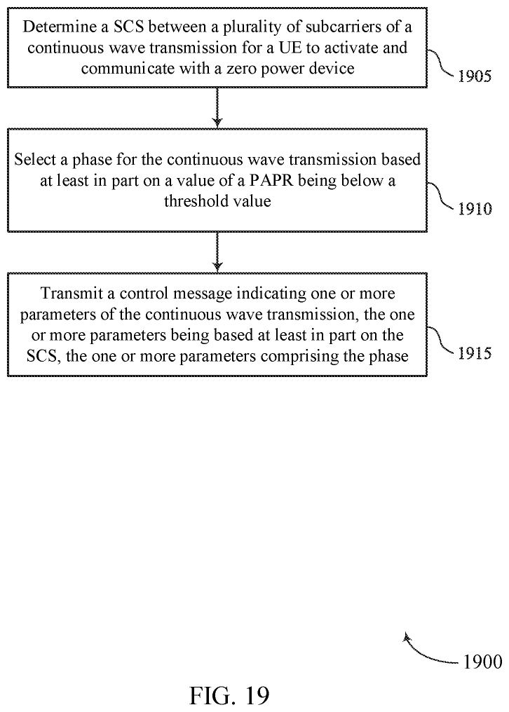

FIG. 19 shows a flowchart illustrating a method 1900 that supports a multiple-subcarrier waveform for backscatter communications in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include determining a SCS between a set of multiple subcarriers of a continuous wave transmission for a UE to activate and communicate with a zero power device. The operations of 1905 may be performed in accordance with examples as disclosed herein. In some examples, aspects of the operations of 1905 may be performed by an SCS component 1225 as described with reference to FIG. 12.

At 1910, the method may include selecting a phase for the continuous wave transmission based on a value of a PAPR ratio being below a threshold value. The operations of 1910 may be performed in accordance with examples as disclosed herein. In some examples, aspects of the operations of 1910 may be performed by a parameter component 1235 as described with reference to FIG. 12.

At 1915, the method may include transmitting a control message indicating one or more parameters of the continuous wave transmission, the one or more parameters being based on the SCS, the one or more parameters including the phase. The operations of 1915 may be performed in accordance with examples as disclosed herein. In some examples, aspects of the operations of 1915 may be performed by a control message component 1230 as described with reference to FIG. 12.

The following provides an overview of aspects of the present disclosure:

Aspect 1: A method for wireless communication at a UE, comprising: selecting, for activating and communicating with a zero power device, one or more parameters of a continuous wave transmission associated with a plurality of subcarriers, the one or more parameters being based at least in part on a subcarrier spacing between each subcarrier of the plurality of subcarriers: transmitting, in accordance with the one or more parameters and via the plurality of subcarriers, the continuous wave transmission for activating and communicating with the zero power device, wherein at least a portion of the continuous wave transmission is modulated in accordance with an amplitude shift keying modulation scheme and includes a set of commands; and receiving, from the zero power device, signaling responsive to the continuous wave transmission and the set of commands.

Aspect 2: The method of aspect 1, wherein selecting the one or more parameters comprises: selecting a phase, an amplitude, or both for the continuous wave transmission based at least in part on a value of a peak-to-average-power ratio being below a threshold value, the one or more parameters comprising the phase, the amplitude, or both, wherein the phase, the amplitude, or both is applied to the continuous wave transmission for activating and communicating with the zero power device.

Aspect 3: The method of aspect 2, further comprising: receiving a message indicating a configuration for generating the phase, the amplitude, or both for the continuous wave transmission, wherein the phase, the amplitude, or both is selected based at least in part on the configuration.

Aspect 4: The method of any of aspects 2 through 3, wherein the phase is a randomized phase, the amplitude is a randomized amplitude, or both, the method further comprising: determining the randomized phase, the randomized amplitude, or both based at least in part on a Zadoff Chu sequence, or a fast Fourier transform, or a discrete Fourier transform, or an M-sequence, or any combination thereof.

Aspect 5: The method of any of aspects 1 through 4, wherein selecting the one or more parameters comprises: selecting a symbol duration of the continuous wave transmission based at least in part on an inverse of a multiple of the subcarrier spacing, wherein the one or more parameters comprise the symbol duration.

Aspect 6: The method of any of aspects 1 through 5, further comprising: applying a linear phase ramp to one or more subcarriers of the plurality of subcarriers to shift the continuous wave transmission in a time domain, wherein the set of commands comprises information modulated in accordance with a pulse position modulation scheme that is based at least in part on the shifted continuous wave transmission.

Aspect 7: The method of any of aspects 1 through 6, further comprising: receiving a message indicating a configuration of the subcarrier spacing, wherein the one or more parameters are selected based on the configuration, and wherein a symbol duration of the continuous wave transmission is based at least in part on the subcarrier spacing.

Aspect 8: The method of any of aspects 1 through 6, further comprising: receiving a message indicating a configuration of a symbol duration of the continuous wave transmission, wherein the one or more parameters are selected based on the configuration, and wherein the subcarrier spacing is based at least in part on the symbol duration.

Aspect 9: The method of any of aspects 1 through 8, wherein respective subcarriers of the plurality of subcarriers are non-contiguous in a frequency domain based at least in part on the subcarrier spacing.

Aspect 10: The method of any of aspects 1 through 9, wherein the one or more parameters comprise a phase associated with the plurality of subcarriers, an amplitude associated with the plurality of subcarriers, a symbol duration of the continuous wave transmission, or any combination thereof.

Aspect 11: The method of any of aspects 1 through 10, further comprising: modulating the continuous wave transmission using the amplitude shift keying modulation scheme.

Aspect 12: The method of any of aspects 1 through 11, wherein the zero power device comprises passive components or active components, or both.

Aspect 13: A method for wireless communication at a network entity, comprising: determining a subcarrier spacing between a plurality of subcarriers of a continuous wave transmission for a UE to activate and communicate with a zero power device; and transmitting a control message indicating one or more parameters of the continuous wave transmission, the one or more parameters being based at least in part on the subcarrier spacing.

Aspect 14: The method of aspect 13, wherein transmitting the control message comprises: transmitting the control message that indicates a configuration for generating a phase for the continuous wave transmission.

Aspect 15: The method of any of aspects 13 through 14, further comprising: selecting a phase, an amplitude, or both for the continuous wave transmission based at least in part on a value of a peak-to-average-power ratio being below a threshold value, the one or more parameters comprising the phase, the amplitude, or both.

Aspect 16: The method of aspect 15, wherein the phase is a randomized phase, the amplitude is a randomized amplitude, or both the method further comprising: determining the randomized phase, the randomized amplitude, or both based at least in part on a Zadoff Chu sequence, or a fast Fourier transform, or a discrete Fourier transform, or an M-sequence, or any combination thereof.

Aspect 17: The method of any of aspects 13 through 16, further comprising: selecting a symbol duration of the continuous wave transmission based at least in part on an inverse of a multiple of the subcarrier spacing, wherein the one or more parameters comprise the symbol duration.

Aspect 18: The method of any of aspects 13 through 17, wherein transmitting the control message comprises: transmitting the control message indicating a configuration of the subcarrier spacing, wherein a symbol duration of the continuous wave transmission is based at least in part on the subcarrier spacing.

Aspect 19: The method of any of aspects 13 through 17, wherein transmitting the control message comprises: transmitting the control message indicating a configuration of a symbol duration of the continuous wave transmission, wherein the subcarrier spacing is based at least in part on the symbol duration.

Aspect 20: The method of any of aspects 13 through 19, wherein respective subcarriers of the plurality of subcarriers are non-contiguous in a frequency domain based at least in part on the subcarrier spacing.

Aspect 21: The method of any of aspects 13 through 20, wherein the one or more parameters comprise a phase associated with the plurality of subcarriers, an amplitude associated with the plurality of subcarriers, a symbol duration of the continuous wave transmission, or any combination thereof.

Aspect 22: An apparatus for wireless communication at a UE, comprising a processor: memory coupled with the processor; and instructions stored in the memory and executable by the processor to cause the apparatus to perform a method of any of aspects 1 through 12.

Aspect 23: An apparatus for wireless communication at a UE, comprising at least one means for performing a method of any of aspects 1 through 12.

Aspect 24: A non-transitory computer-readable medium storing code for wireless communication at a UE, the code comprising instructions executable by a processor to perform a method of any of aspects 1 through 12.

Aspect 25: An apparatus for wireless communication at a network entity, comprising a processor: memory coupled with the processor; and instructions stored in the memory and executable by the processor to cause the apparatus to perform a method of any of aspects 13 through 21.

Aspect 26: An apparatus for wireless communication at a network entity, comprising at least one means for performing a method of any of aspects 13 through 21.

Aspect 27: A non-transitory computer-readable medium storing code for wireless communication at a network entity, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
selecting, for activating and communicating with a zero power device, one or more parameters of a continuous wave transmission associated with a plurality of subcarriers, the one or more parameters being based at least in part on a subcarrier spacing between each subcarrier of the plurality of subcarriers:
transmitting, in accordance with the one or more parameters and via the plurality of subcarriers, the continuous wave transmission for activating and communicating with the zero power device, wherein at least a portion of the continuous wave transmission is modulated in accordance with an amplitude shift keying modulation scheme and includes a set of commands; and
receiving, from the zero power device, signaling responsive to the continuous wave transmission and the set of commands.

2. The method of claim 1, wherein selecting the one or more parameters comprises:
selecting a phase, an amplitude, or both for the continuous wave transmission based at least in part on a value of a peak-to-average-power ratio being below a threshold value, the one or more parameters comprising the phase, the amplitude, or both, wherein the phase, the amplitude, or both is applied to the continuous wave transmission for activating and communicating with the zero power device.

3. The method of claim 2, further comprising:
receiving a message indicating a configuration for generating the phase, the amplitude, or both for the continuous wave transmission, wherein the phase, the amplitude, or both is selected based at least in part on the configuration.

4. The method of claim 2, wherein the phase is a randomized phase, the amplitude is a randomized amplitude, or both, the method further comprising:
determining the randomized phase, the randomized amplitude, or both based at least in part on a Zadoff Chu sequence, or a fast Fourier transform, or a discrete Fourier transform, or an M-sequence, or any combination thereof.

5. The method of claim 1, wherein selecting the one or more parameters comprises:
selecting a symbol duration of the continuous wave transmission based at least in part on an inverse of a multiple of the subcarrier spacing, wherein the one or more parameters comprise the symbol duration.

6. The method of claim 1, further comprising:
applying a linear phase ramp to one or more subcarriers of the plurality of subcarriers to shift the continuous wave transmission in a time domain, wherein the set of commands comprises information modulated in accordance with a pulse position modulation scheme that is based at least in part on the shifted continuous wave transmission.

7. The method of claim 1, further comprising:
receiving a message indicating a configuration of the subcarrier spacing, wherein the one or more parameters are selected based on the configuration, and wherein a symbol duration of the continuous wave transmission is based at least in part on the subcarrier spacing.

8. The method of claim 1, further comprising:
receiving a message indicating a configuration of a symbol duration of the continuous wave transmission, wherein the one or more parameters are selected based on the configuration, and wherein the subcarrier spacing is based at least in part on the symbol duration.

9. The method of claim 1, wherein respective subcarriers of the plurality of subcarriers are non-contiguous in a frequency domain based at least in part on the subcarrier spacing.

10. The method of claim 1, wherein the one or more parameters comprise a phase associated with the plurality of subcarriers, an amplitude associated with the plurality of subcarriers, a symbol duration of the continuous wave transmission, or any combination thereof.

11. The method of claim 1, further comprising:
modulating the continuous wave transmission using the amplitude shift keying modulation scheme.

12. The method of claim 1, wherein the zero power device comprises passive components or active components, or both.

13. A method for wireless communication at a network entity, comprising:
determining a subcarrier spacing between a plurality of subcarriers of a continuous wave transmission for a user equipment (UE) to activate and communicate with a zero power device; and
transmitting a control message indicating one or more parameters of the continuous wave transmission, the one or more parameters being based at least in part on the subcarrier spacing.

14. The method of claim 13, wherein transmitting the control message comprises:
transmitting the control message that indicates a configuration for generating a phase for the continuous wave transmission.

15. The method of claim 13, further comprising:
selecting a phase, an amplitude, or both for the continuous wave transmission based at least in part on a value of a peak-to-average-power ratio being below a threshold value, the one or more parameters comprising the phase, the amplitude, or both.

16. The method of claim 15, wherein the phase is a randomized phase, the amplitude is a randomized amplitude, or both the method further comprising:
determining the randomized phase, the randomized amplitude, or both based at least in part on a Zadoff Chu sequence, or a fast Fourier transform, or a discrete Fourier transform, or an M-sequence, or any combination thereof.

17. The method of claim 13, further comprising:
selecting a symbol duration of the continuous wave transmission based at least in part on an inverse of a multiple of the subcarrier spacing, wherein the one or more parameters comprise the symbol duration.

18. The method of claim 13, wherein transmitting the control message comprises:
transmitting the control message indicating a configuration of the subcarrier spacing, wherein a symbol duration of the continuous wave transmission is based at least in part on the subcarrier spacing.

19. The method of claim 13, wherein transmitting the control message comprises:
transmitting the control message indicating a configuration of a symbol duration of the continuous wave transmission, wherein the subcarrier spacing is based at least in part on the symbol duration.

20. The method of claim 13, wherein respective subcarriers of the plurality of subcarriers are non-contiguous in a frequency domain based at least in part on the subcarrier spacing.

21. The method of claim 13, wherein the one or more parameters comprise a phase associated with the plurality of subcarriers, an amplitude associated with the plurality of subcarriers, a symbol duration of the continuous wave transmission, or any combination thereof.

22. An apparatus for wireless communication at a user equipment (UE), comprising:
a processor:
memory coupled with the processor; and
instructions stored in the memory and executable by the processor to cause the apparatus to:
select, for activating and communicating with a zero power device, one or more parameters of a continuous wave transmission associated with a plurality of subcarriers, the one or more parameters being based at least in part on a subcarrier spacing between each subcarrier of the plurality of subcarriers;
transmit, in accordance with the one or more parameters and via the plurality of subcarriers, the continuous wave transmission for activating and communicating with the zero power device, wherein at least a portion of the continuous wave transmission is modulated in accordance with an amplitude shift keying modulation scheme and includes a set of commands; and
receive, from the zero power device, signaling responsive to the continuous wave transmission and the set of commands.

23. The apparatus of claim 22, wherein the instructions to select the one or more parameters are executable by the processor to cause the apparatus to:
selecting a phase, an amplitude, or both for the continuous wave transmission based at least in part on a value of a peak-to-average-power ratio being below a threshold value, the one or more parameters comprising the phase, the amplitude, or both, wherein the phase, the amplitude, or both is applied to the continuous wave transmission for activating and communicating with the zero power device.

24. The apparatus of claim 23, wherein the instructions are further executable by the processor to cause the apparatus to:
receiving a message indicating a configuration for generating the phase, the amplitude, or both for the continuous wave transmission, wherein the phase, the amplitude, or both is selected based at least in part on the configuration.

25. The apparatus of claim 23, wherein the phase is a randomized phase, the amplitude is a randomized amplitude, or both, and the instructions are further executable by the processor to cause the apparatus to:
determining the randomized phase, the randomized amplitude, or both based at least in part on a Zadoff Chu sequence, or a fast Fourier transform, or a discrete Fourier transform, or an M-sequence, or any combination thereof.

26. The apparatus of claim 22, wherein the instructions to select the one or more parameters are executable by the processor to cause the apparatus to:
select a symbol duration of the continuous wave transmission based at least in part on an inverse of a multiple of the subcarrier spacing, wherein the one or more parameters comprise the symbol duration.

27. The apparatus of claim 22, wherein the instructions are further executable by the processor to cause the apparatus to:
apply a linear phase ramp to one or more subcarriers of the plurality of subcarriers to shift the continuous wave transmission in a time domain, wherein the set of commands comprises information modulated in accordance with a pulse position modulation scheme that is based at least in part on the shifted continuous wave transmission.

28. The apparatus of claim 22, wherein the instructions are further executable by the processor to cause the apparatus to:
receive a message indicating a configuration of the subcarrier spacing, wherein the one or more parameters are selected based on the configuration, and wherein a symbol duration of the continuous wave transmission is based at least in part on the subcarrier spacing.

29. The apparatus of claim 22, wherein the instructions are further executable by the processor to cause the apparatus to:
receive a message indicating a configuration of a symbol duration of the continuous wave transmission, wherein the one or more parameters are selected based on the configuration, and wherein the subcarrier spacing is based at least in part on the symbol duration.

30. An apparatus for wireless communication at a network entity, comprising:
a processor;
memory coupled with the processor; and
instructions stored in the memory and executable by the processor to cause the apparatus to:
determine a subcarrier spacing between a plurality of subcarriers of a continuous wave transmission for a user equipment (UE) to activate and communicate with a zero power device; and
transmit a control message indicating one or more parameters of the continuous wave transmission, the one or more parameters being based at least in part on the subcarrier spacing.
